(19) United States
(12) Patent Application Publication
(10) Pub. No.: US 2019/0258925 A1
(43) Pub. Date: Aug. 22, 2019

(54) PERFORMING ATTRIBUTE-AWARE BASED TASKS VIA AN ATTENTION-CONTROLLED NEURAL NETWORK

(71) Applicant: Adobe Inc., San Jose, CA (US)

(72) Inventors: Haoxiang Li, Hoboken, NJ (US); Xiaohui Shen, San Jose, CA (US); Xiangyun Zhao, Evanston, IL (US)

(21) Appl. No.: 15/900,351

(22) Filed: Feb. 20, 2018

(51) Int. Cl. G06N 3/08

(52) U.S. Cl. CPC G06N 3/08

(57) ABSTRACT

This disclosure covers methods, non-transitory computer readable media, and systems that learn attribute attention projections for attributes of digital images and parameters for an attention controlled neural network. By iteratively generating and comparing attribute-modulated-feature vectors from digital images, the methods, non-transitory computer readable media, and systems update attribute attention projections and parameters indicating either one (or both) of a correlation between some attributes of digital images and a discorrelation between other attributes of digital images. In certain embodiments, the methods, non-transitory computer readable media, and systems use the attribute attention projections in an attention controlled neural network as part of performing one or more tasks.

### BACKGROUND

Computer systems increasingly train neural networks to detect a variety of attributes from the networks' inputs or perform a variety of tasks based on the networks' outputs. For example, some existing neural networks learn to generate features (from various inputs) for use in computer visions tasks, such as detecting different types of objects in images or semantic segmentation of images. By contrast, some existing neural networks learn to generate features that correspond to sentences for translation from one language to another.

Despite the increased use and usefulness of neural networks, training such networks to identify different attributes or facilitate different tasks often includes computer-processing inaccuracies and inefficiencies. Some existing neural networks, for instance, learn shared parameters for identifying multiple attributes or performing multiple tasks. But such shared parameters sometimes interfere with the accuracy of the neural-network-training process. Indeed, a neural network that uses shared parameters for different (and unrelated) attributes or tasks can inadvertently associate attributes or tasks that have no correlation and interfere with accurately identifying such attributes or performing such tasks.

For instance, a neural network that learns shared parameters for identifying certain objects within images may inadvertently learn parameters that inhibit the network's ability to identify such objects. While a first object may have a strong correlation with a second object, the first object may have a weak correlation (or no correlation) with a third object—despite sharing parameters. Accordingly, existing neural networks may learn shared parameters that interfere with identifying objects based on an incorrect correlation. In particular, two tasks of weak correlation may distract or even compete against each other during training and consequently undermine the training of other tasks. Such problems are exacerbated when the number of tasks involved increase.

In contrast to existing neural networks that share parameters, some neural networks independently learn to identify different attributes or perform different tasks. But training neural networks separately can introduce computing efficiencies, consume valuable computer processing time and memory, and overlook correlations between attributes or tasks. For example, training independent neural networks to identify different attributes or perform different tasks can consume significantly more training time and computer processing power than training a single neural network. As another example, training independent neural networks to identify different attributes or perform different tasks may prevent a neural network from learning parameters that indicate a correlation between attributes or tasks (e.g., learning parameters that inherently capture a correlation between clouds and skies).

Accordingly, existing neural networks can have significant computational drawbacks. While some existing neural networks that share parameters interfere with the accuracy to identify multiple attributes or perform multiple tasks, other independently trained neural networks overlook correlations and consume significant processing time and power.

### SUMMARY

This disclosure describes one or more embodiments of methods, non-transitory computer readable media, and systems that solve the foregoing problems in addition to providing other benefits. For example, in one or more embodiments, the disclosed systems learn attribute attention projections. The disclosed systems insert the learned attribute attention projections into a neural network to facilitate the coupling and feature sharing of relevant attributes, while disentangling the learning of irrelevant attributes. During training, the systems update attribute attention projections and neural network parameters indicating either one (or both) of a correlation between some attributes of digital images and a discorrelation between other attributes of digital images. In certain embodiments, the systems use the attribute attention projections with an attention-controlled neural network as part of performing one or more tasks, such as image retrieval.

For instance, in some embodiments, the systems learn an attribute attention projection for an attribute category. In particular, the systems use the attribute attention projection to generate an attribute-modulated-feature vector using an attention-controlled neural network. To generate the attribute-modulated-feature vector, the systems feed an image to the attention-controlled neural network and insert the attribute attention projection between layers of the attention-controlled neural network. During training, the systems jointly learn an updated attribute attention projection and updated parameters of the attention-controlled neural network using end-to-end learning. In certain embodiments, the systems perform multiple iterations of generating and learning additional attribute attention projections indicating correlations (or discorrelations) between attribute categories.

### BRIEF DESCRIPTION OF THE DRAWINGS

The detailed description refers to the drawings briefly described below.

FIG. 1 illustrates a conceptual diagram of an attention controlled system that uses an attribute attention projection within an attention controlled neural network to generate feature vectors for a task in accordance with one or more embodiments.

FIG. 2 illustrates attribute categories that cause destructive interference when training a neural network in accordance with one or more embodiments.

FIGS. 3A-3B illustrate an attention controlled system training an attention controlled neural network and learning attribute attention projections for attribute categories in accordance with one or more embodiments.

FIG. 4 illustrates a gradient modulator within layers of an attention controlled neural network in accordance with one or more embodiments.

FIG. 5 illustrates an attention controlled neural network in accordance with one or more embodiments.

FIG. 6 illustrates differences in attribute attention projections during training of an attention controlled neural network in accordance with one or more embodiments.

FIG. 7 illustrates an attention controlled system that uses an attribute attention projection in connection with an attention controlled neural network to generate feature vectors for a task in accordance with one or more embodiments.

FIG. 8A illustrates a table comparing the accuracy of an attention controlled system in performing image retrieval based on faces to existing neural-network systems in accordance with one or more embodiments.

FIG. 8B illustrates a table comparing the accuracy of an attention controlled system in performing image retrieval based on faces when more layers are modulated in accordance with one or more embodiments.

FIG. 8C illustrates a table comparing the accuracy of an attention controlled system in performing image retrieval based on products to existing neural-network systems in accordance with one or more embodiments

FIG. 9 illustrates a block diagram of an environment in which an attention controlled system and an attention controlled neural network can operate in accordance with one or more embodiments.

FIG. 10 illustrates a schematic diagram of the attention controlled system of FIG. 9 in accordance with one or more embodiments.

FIG. 11 illustrates a flowchart of a series of acts for training an attention controlled neural network in accordance with one or more embodiments.

FIG. 12 illustrates a flowchart of a series of acts for applying an attention controlled neural network in accordance with one or more embodiments.

FIG. 13 illustrates a block diagram of an exemplary computing device for implementing one or more embodiments of the present disclosure.

### DETAILED DESCRIPTION

This disclosure describes one or more embodiments of an attention controlled system that learns attribute attention projections for attributes of digital images. As part of learning, the attention controlled system inputs training images into the attention controlled neural network and generates and compares attribute-modulated-feature vectors. Through multiple updates, the attention controlled system learns attribute attention projections that indicate either one (or both) of a correlation between some attributes and a discorrelation between other attributes. In certain embodiments, the attention controlled system uses the attribute attention projections to facilitate performing one or more attribute based tasks, such as image retrieval.

In some embodiments, the attention controlled system generates an attribute attention projection for an attribute category. During training, the attention controlled system jointly learns the attribute attention projection and parameters of the attention controlled neural network using end-to-end training. As mentioned, such training can encourage correlated attributes to share more features, and at the same time disentangle the feature learning of irrelevant attributes.

In some embodiments, the attention controlled system trains an attention controlled neural network. The training is an iterative process that optionally involves different attribute attention projections corresponding to different attribute categories. As part of the training processing, the attention controlled system inserts an attribute attention projection in between layers of the attention controlled neural network. For example, in certain embodiments, the attention controlled system inserts a gradient modulator between layers, where the gradient modulator includes an attribute attention projection. Such gradient modulators may be inserted into (and used to train) any type of neural network.

In addition to generating attribute-modulated-feature vectors, the attention controlled system optionally uses end-to-end learning for multi-task learning. In particular, the attention controlled system uses end-to-end learning to update/learn attribute attention projections and parameters of the attention controlled neural network. For example, the attention controlled system may use a loss function to compare an attribute-modulated-feature vector to a reference vector (e.g., another attribute-modulated-feature vector). In certain embodiments, the attention controlled system uses a triplet loss function to determine a distance margin between an anchor image and a positive image (an image with the attribute) and another distance margin between the anchor image and a negative image (an image with a less prominent version of the attribute or without the attribute). Based on the distance margins, the attention controlled system uses backpropagation to jointly update the attribute attention projection and parameters of the attention controlled neural network.

As the attention controlled system performs multiple training iterations, in certain embodiments, the attention controlled system learns different attribute attention projections for attribute categories that reflect a correlation between some attribute categories and a discorrelation between other attribute categories. For instance, as the attention controlled system learns a first attribute attention projection and a second attribute attention projection, the two attribute attention projections may change into relatively similar values (or relatively dissimilar) values to indicate a correlation (or a discorrelation) between the attribute category for the first attribute attention projection and the attribute category for the second attribute attention projection. To illustrate, the first and second attribute attention projections may indicate (i) a correlation between a smile in a mouth-expression category and an open mouth in a mouth-configuration category or (ii) a discorrelation between a smile in a mouth-expression category and an old face in a face-age category.

Once trained, the attention controlled system uses an attribute attention projection in the attention controlled neural network to generate an attribute-modulated-feature vector for a task. For example, in some embodiments, the attention controlled system generates an attribute attention projection based on an attribute code for an attribute category of a digital input image. Based on the attribute attention projection, the attention controlled system uses an attention controlled neural network to generate an attribute-modulated-feature vector for the digital input image. As part of generating the vector, the attention controlled system inserts the attribute attention projection between layers of the attention controlled neural network. Based on the digital input image and the attribute-modulated-feature vector, the attention controlled system subsequently performs a task, such as retrieving images with attributes that correspond to the digital input image.

In particular, the attention controlled system applies the attribute attention projection to feature map(s) extracted from an image by the neural network. By applying the attribute attention projection, the attention controlled system generates a discriminative feature map for the image. Accordingly, in some cases, the attention controlled system uses attribute attention projections to modify feature maps produced by layers of the attention controlled neural network. As suggested above, the attention controlled neural network outputs an attribute-modulated-feature vector for the image based on the discriminative feature map(s).

As suggested above, the attention controlled system inserts an attribute attention projection for an attribute category in between layers of the attention controlled neural network. In certain implementations, the attention controlled system inserts the attribute attention projection in between multiple different layers of the attention controlled neural network. For example, the attention controlled neural network may apply an attribute attention projection in between a first set of layers and (again) apply the attribute attention projection in between a second set of layers. By using multiple applications of an attribute attention projection, the attention controlled system can increase the accuracy of the attribute-modulated-feature vector for a digital input image.

In certain embodiments, the attention controlled system uses an attribute-modulated-feature vector to perform a task. The task may comprise an attribute-based task. For instance, the attention controlled system may retrieve an output digital image from an image database that has an attribute or attributes that corresponds to an input digital image. Alternatively, the attention controlled system may identify objects within a digital image.

As an example, the attention controlled system can, given an input digital image and an attribute code for an attribute category, retrieve other images that are similar to the input image and include an attribute corresponding to the attribute category similar to an attribute of the input digital image. Thus, rather than just returning a similar image, the attention controlled system can return a similar image that includes one or more granular attributes of the input digital image. For example, when performing the task of image retrieval, the attention controlled system can return images that are similar and include an attribute (e.g., smile, shadow, bald, eyebrows, chubby, double-chin, high-cheekbone, goatee, mustache, no-beard, sideburns, bangs, straight-hair, wavy-hair, receding-hairline, bags under the eyes, bushy eyebrows, young, oval-face, open-mouth) or multiple attributes (e.g., smile+young+open mouth) of the input digital image.

The disclosed attention controlled system overcomes several technical deficiencies that hinder existing neural networks. As noted above, some existing neural networks share parameters for different (and unrelated) attributes or tasks and thereby inadvertently interfere with a neural network's ability to accurately identifying such attributes (e.g., in images) or performing such tasks. In other words, unrelated attributes or tasks destructively interfere with existing neural networks' ability to learn parameters for extracting features corresponding to such attributes or tasks. By contrast, in some embodiments, the disclosed attention controlled system learns attribute attention projections that correspond to an attribute category. As the attention controlled system learns such attribute attention projections, the attribute attention projections represent relatively similar values indicating a correlation between related attributes or relatively dissimilar values indicating a discorrelation between unrelated attributes. Accordingly, the attribute attention projections eliminate (or compensate for) a technological problem hindering existing neural networks—destructive interference between unrelated attributes or tasks.

As just suggested, the disclosed attention controlled system also generates more accurate feature vectors corresponding to attributes of digital images than existing neural networks. Some independently trained neural networks do not detect a correlation between attributes or tasks because the networks are trained to determine features of a single attribute or task. By generating attribute attention projections corresponding to an attribute category, however, the attention controlled system generates attribute-modulated-feature vectors that more accurately correspond to correlated attributes of a digital input image. The attention controlled system leverages such correlations to improve the attribute-modulated-feature vectors output by the attention controlled neural network.

Additionally, the disclosed attention controlled system also expedites one or both of the training and application of neural networks used for multiple tasks. Instead of training and using multiple neural networks dedicated to an individual attribute or task, the disclosed attention controlled system optionally trains and uses a single attention controlled neural network that can generate attribute-modulated-feature vectors corresponding to multiple attributes or tasks. As the attributes or tasks relevant to a neural network increase, the computer-processing efficiencies likewise increases for the disclosed attention controlled systems. By using a single neural network, the attention controlled system uses less computer processing time and imposes less computer processing load to train or use the attention controlled neural network than existing neural networks.

Additionally, the disclosed attention controlled system also provides greater flexibility in connection with the increased accuracy. For example, the disclosed attention controlled system can function with an arbitrary neural network architecture. In other words, the use of the attribute attention projections is not limited to particular neural network architecture. Thus, the attribute attention projection can be employed with a relatively simple neural network to provide further savings of processing power (e.g., to allow for deployment on mobile phones or other devices with limited computing resources) or can be employed with complex neural networks to provide increased accuracy and more robust attributes and attributes combinations.

With regard to flexibility, the disclosed attention controlled systems are also loss function agnostic. In other words, the disclosed attention controlled systems can employ sophisticated loss functions during training to learn more discriminate features for all tasks. Alternatively, the disclosed attention controlled systems can employ relatively simple loss functions for ease and speed of training.

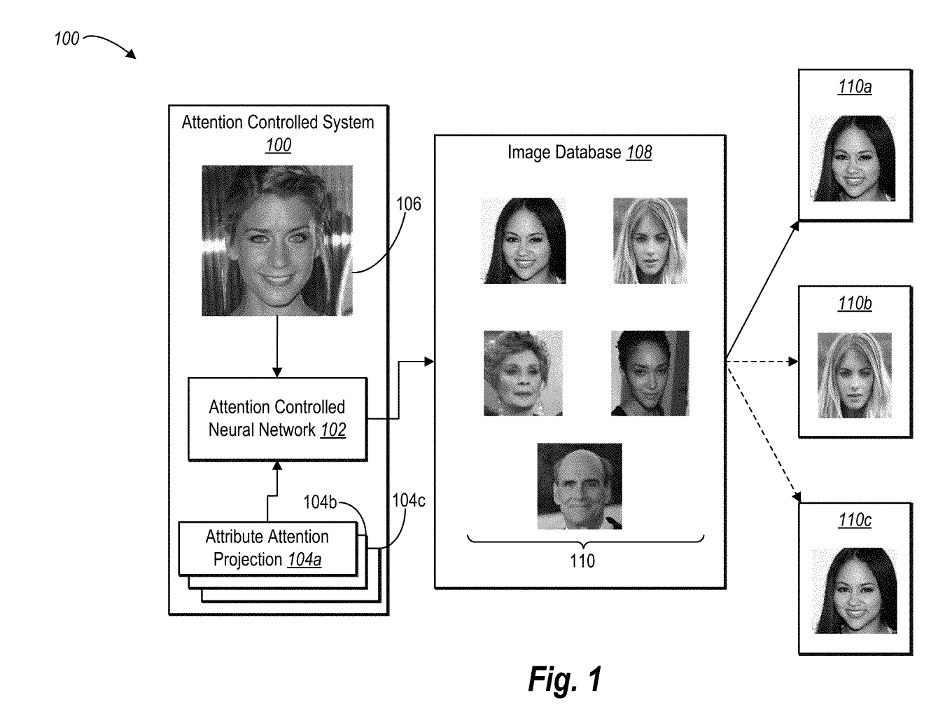

Turning now to FIG. 1, this figure illustrates an overview of an attention controlled system that uses an attribute attention projection within an attention controlled neural network to generate attribute-modulated-feature vectors for a task. As an overview of FIG. 1, an attention controlled system 100 generates and inserts an attribute attention projection 104a in between layers of an attention controlled neural network 102. The attention controlled system 100 further inputs a digital input image 106 into the attention controlled neural network 102. The attention controlled neural network 102 then applies the attribute attention projection 104a to features extracted from the digital input image 106. Based on applying the attribute attention projection 104a to one or more features, the attention controlled neural network 102 generates an attribute-modulated-feature vector, and the attention controlled system performs a task—retrieving a digital output image 110a corresponding to the digital input image 106.

As used in this disclosure, the term “attribute attention projection” refers to a projection, vector, or weight specific to an attribute category or a combination of attribute categories. In some embodiments, for instance, an attribute attention projection maps a feature of a digital image to a modified version of the feature. For example, in some embodiments, an attribute attention projection comprises a channel-wise scaling vector or a channel-wise projection matrix. The attention controlled system 100 optionally applies the channel-wise scaling vector or channel-wise projection matrix to a feature map extracted the digital input image 106 to create a discriminative feature map. This disclosure provides additional examples of an attribute attention projection below.

As just noted, an attribute attention projection may be specific to an attribute category. As used in this disclosure, the term “attribute category” refers to a category for a quality or characteristic of an input for a neural network. The term “attribute” in turn refers to a quality or characteristic of an input for a neural network. An attribute category may include, for example, a quality or characteristic of a digital input image for a neural network, such as a category for a facial feature or product feature. As shown in FIG. 1, an attribute category for the attribute attention projection 104a may be a facial-feature category for an age, gender, mouth expression, or some other facial feature for the face in the digital input image 106.

For purposes of illustration, the attribute attention projection 104a shown in FIG. 1 is specific to a mouth-expression category. But any other attribute category could be used in the alternative. As indicated by FIG. 1, the attention controlled neural network 102 extracts features from the digital input image 106 and applies the attribute attention projection 104a to one or more of those features. By applying the attribute attention projection 104a, the attention controlled system 100 modifies the feature to weight (i.e., give attention to) a particular attribute category for the digital input image 106.

As further shown in FIG. 1, the attention controlled system 100 includes the attention controlled neural network 102. As used in this disclosure, the term “neural network” refers to a machine learning model trained to approximate unknown functions based on training input. In particular, the term “neural network” can include a model of interconnected artificial neurons that communicate and learn to approximate complex functions and generate outputs based on inputs provided to the model.

Relatedly, the term “attention controlled neural network” refers to a neural network trained to generate attention controlled features corresponding to an attribute category. In particular, an attention controlled neural network is trained to generate attribute-modulated-feature vectors corresponding to attribute categories of a digital input image. An attention controlled neural network may be various types of neural networks. For example, an attention controlled neural network may include, but is not limited to, a convolutional neural network, a feedforward neural network, a fully convolutional neural network, a recurrent neural network, or any other suitable neural network.

As noted above, the attention controlled neural network 102 generates an attribute-modulated-feature vector based on the digital input image 106. As used in this disclosure, the term “attribute-modulated-feature vector” refers to a feature vector adjusted to indicate, or focus on, an attribute. In particular, an attribute-modulated-feature vector includes a feature vector based on features adjusted by an attribute attention projection. For example, in some cases, an attribute-modulated-feature vector includes values that correspond to an attribute category of a digital input image. As suggested by FIG. 1, the attention controlled neural network 102 generates an attribute-modulated-feature vector that includes values corresponding to an attribute category of the digital input image 106. For purposes of illustration, the attribute-modulated-feature vector includes values corresponding to a mouth-expression category (e.g., indicating that a face within the digital input image 106 includes a smile or no smile).

After generating an attribute-modulated-feature vector, the attention controlled system 100 also uses the attribute-modulated-feature vector to perform a task. As indicated by FIG. 1, the attention controlled system 100 searches an image database 108 for a digital image corresponding to the digital input image 106. The image database 108 includes digital images 110 with corresponding feature vectors. Accordingly, the attention controlled system 100 uses the feature vectors corresponding to the digital images 110 to identify an output digital image that corresponds to the digital input image 106. For example, the attention controlled system 100 searches the image database 108 for one or more digital images corresponding to feature vectors similar to (or with the least difference from) the attribute-modulated-feature vector for the digital input image 106.

As shown in FIG. 1, the attention controlled system 100 identifies a digital output image 110a from among the digital images 110 as corresponding to the digital input image 106. Based on the similarity between the feature vector for the digital output image 110a and the attribute-modulated-feature vector for the digital input image 106, the attention controlled system 100 determines that the digital output image 110a includes an attribute similar to a corresponding attribute of the digital input image 106. Here, the attention controlled system 100 retrieves the digital output image 110a because the feature vector indicates that it includes a facial feature (e.g., a smile) similar to a facial feature within the digital input image 106.

As further indicated by FIG. 1, the attention controlled system 100 may likewise use the attention controlled neural network 102 to perform multiple tasks. For example, the attention controlled system 100 may generate an attribute attention projection 104b for an additional attribute category (e.g., a face-age category) and use the attention controlled neural network 102 to generate an additional attribute-modulated-feature vector for the digital input image 106. Having generated an additional attribute-modulated-feature vector, the attention controlled system optionally retrieves a digital output image 110b from among the digital images 110 because the feature vector for the digital output image 110b indicates that it includes a different facial feature (e.g., a young face) similar to a facial feature within the digital input image 106. The attention controlled system 100 may similarly generate an attribute attention projection 104c for a further attribute category to facilitate retrieving a digital output image 110c that includes a facial feature (e.g., a female looking face) similar to a different facial feature from another attribute category (e.g., gender).

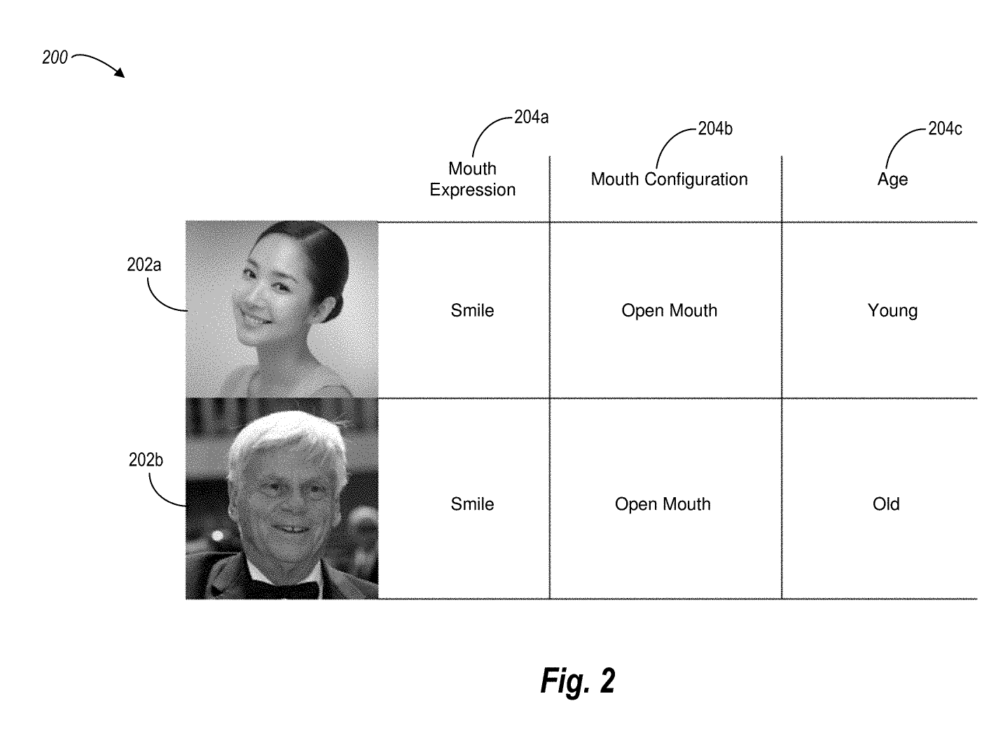

As noted above, the attention controlled system 100 solves a destructive-interference problem that hinders certain neural networks. FIG. 2 illustrates both related attribute categories and unrelated attribute categories—the latter of which may cause destructive interference when training a neural network. In particular, the chart 200 includes a first digital image 202a and a second digital image 202b. Both the first digital image 202a and the second digital image 202b include attributes that correspond to a first attribute category 204a, a second attribute category 204b, and a third attribute category 204c.

As shown in FIG. 2, both the first digital image 202a and the second digital image 202b include a smile corresponding to the first attribute category 204a and an open mouth corresponding to the second attribute category 204b. Because having a smile correlates with an open mouth—and having no smile correlates with a closed mouth—the first attribute category 204a and the second attribute category 204b correlate to each other. A skilled artisan will recognize that the first attribute category 204a and the second attribute category 204b have a relationship of correlation, but not necessarily a relationship of causation.

As further shown in FIG. 2, both the first digital image 202a and the second digital image 202b also include attributes corresponding to unrelated attribute categories. The first digital image 202a includes a young face corresponding to the third attribute category 204c and the second digital image 202b includes an old face corresponding to the third attribute category 204c. Because having a smile does not correlate with having a young face—and having no smile does not correlate to having an old face—the first attribute category 204a and the third attribute category 204c do not correlate. In other words, smiling does not correlate with or depend on whether a person has a young or old looking face. The second attribute category 204b and the third attribute category 204c likewise do not correlate. Having an open or closed mouth does not correlate with or depend on whether a person has a young or old looking face.

As noted above, training a neural network based on unrelated attribute categories can cause destructive interference. Existing neural networks often use gradient descent and supervision signals from different attribute categories to jointly learn shared parameters for multiple attribute categories. But some unrelated attribute categories introduce conflicting training signals that hinder the process of updating shared parameters. For example, two unrelated attribute categories may drag gradients propagated from different attributes in conflicting or opposite directions. This conflicting direction of one attribute category on another attribute category is called destructive interference.

To illustrate, let θ represent the parameters of a neural network F with an input image of I and an output of f, where f=F(I|θ). The following function depicts a gradient for the shared parameters θ:

$$∇ θ = \frac{\partial L}{\partial f} \frac{\partial f}{\partial θ} \qquad ( 1 )$$

In function (1), L represents a loss function. During training,

$$\frac{\partial L}{\partial f}$$

directs the neural network F to learn the parameters θ. In some cases, a discriminative loss encourages fᵢ and fⱼ to become similar for images Iᵢ and Iⱼ from the same class (e.g., when the attribute categories for Iᵢ and Iⱼ are correlated). But the relationship between Iᵢ and Iⱼ can change depending on the attribute categories. For example, when the neural network F identifies features for a different pair of attribute categories, the outputs fᵢ and fⱼ may indicate conflicting directions. During the training process for all attribute categories collectively, the update directions for the parameters θ may therefore conflict. As suggested above, the conflicting directions for updating the parameters θ represent destructive interference.

In particular, if the neural network F iterates through a mini batch of training images for attribute category a and a′, then ∇θ=∇θₐ+∇θ_{a′}, where ∇θa/a′ represents gradients from training images of attribute categories a/a′. Gradients for two unrelated attribute categories are negatively interfering with the neural network F from learning parameters for both attribute categories when:

A_{a,a′}=sign( [symbol] ∇θₐ,∇θ_{a′} [symbol] )=−1 (2)

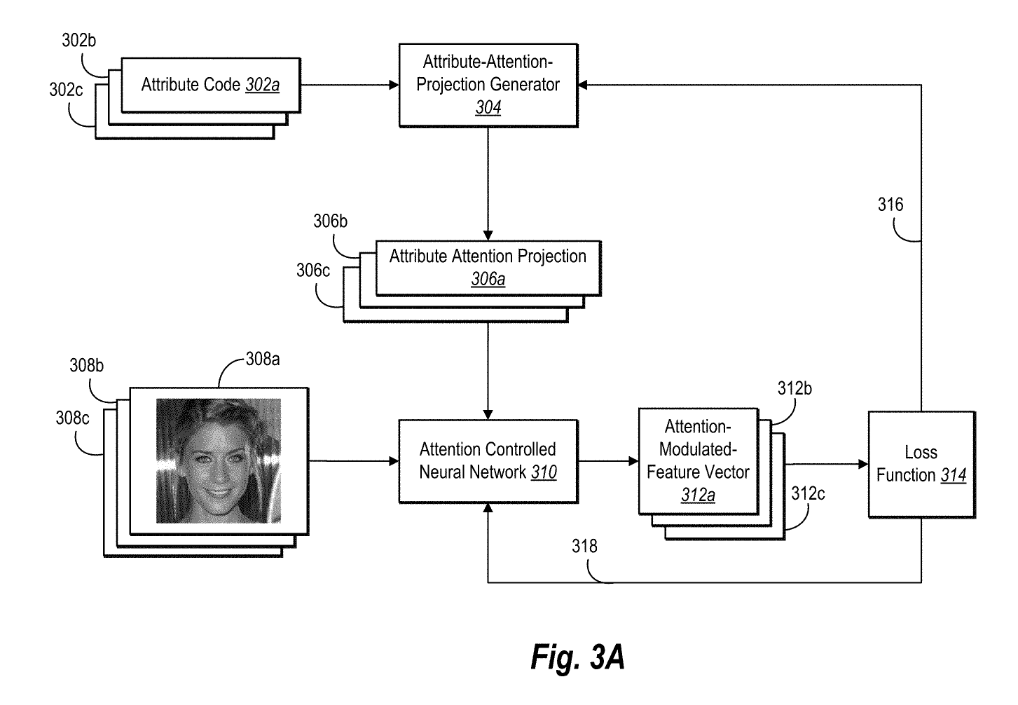

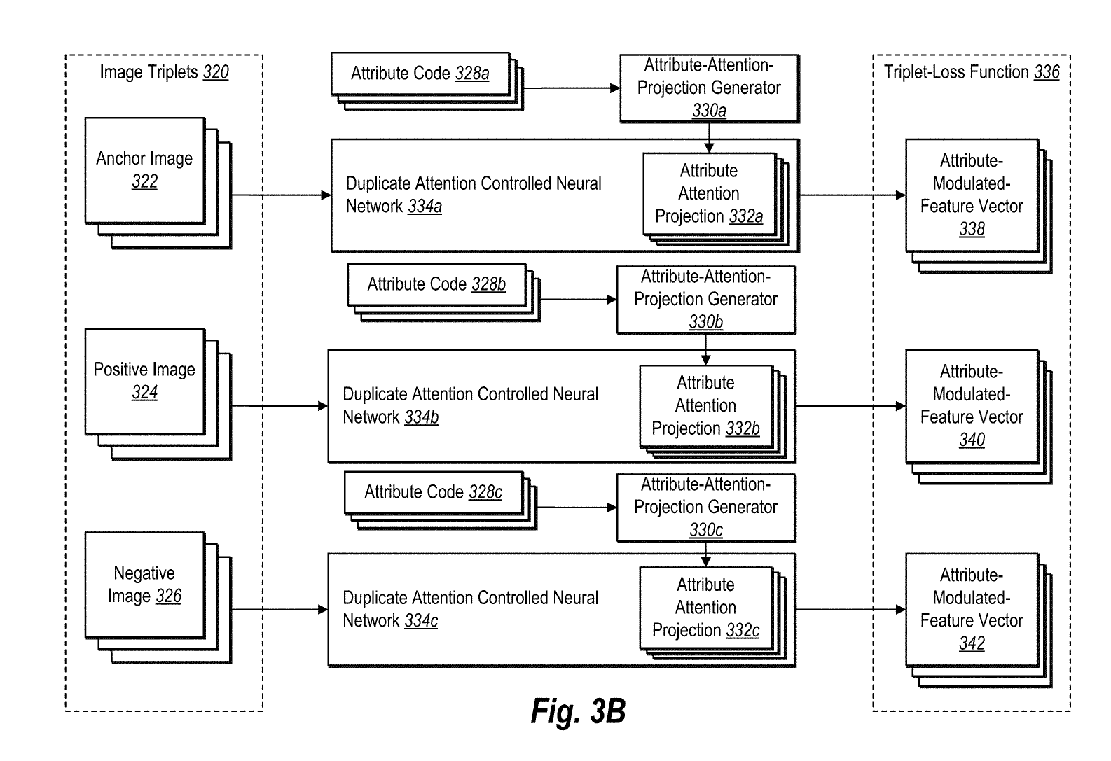

As noted above, in certain embodiments, the attention controlled system 100 trains a neural network to learn attribute attention projections and parameters that avoid or solve the destructive-interference problem in an efficient manner. FIGS. 3A-3B illustrate the attention controlled system training an attention controlled neural network and learning attribute attention projections for attribute categories. While FIG. 3A provides an overview of a training process, FIG. 3B provides an example of training an attention controlled neural network using image triplets and a triplet-loss function.

In particular, FIG. 3A depicts multiple training iterations of an attention controlled neural network 310. In each iteration, the attention controlled system (i) inputs a training image into the attention controlled neural network 310 to generate an attribute-modulated-feature vector for the training image and (ii) determines a loss from a loss function as a basis for updating an attribute attention projection and parameters of the attention controlled neural network 310. The following paragraphs describe the attention controlled system 100 performing actions for one training iteration followed by actions in other training iterations.

As depicted, the attention controlled neural network 310 may be any suitable neural network. For example, the attention controlled neural network 310 may be, but is not limited to, a feedforward neural network, such as an auto-encoder neural network, convolutional neural network, a fully convolutional neural network, probabilistic neural network, or time-delay neural network; a modular neural network; a radial basis neural network; a regulatory feedback neural network; or a recurrent neural network, such as a Boltzmann machine, a learning vector quantization neural network, or a stochastic neural network.

As shown in FIG. 3A, the attention controlled system 100 inputs an attribute code 302a into an attribute-attention-projection generator 304 to generate an attribute attention projection 306a. The term “attribute code” refers to a reference or label for an attribute category or a combination of attribute categories. For instance, in some embodiments, an attribute code includes a numeric reference, an alphanumeric reference, a binary code, or any other suitable label or reference for an attribute category. As shown in FIG. 3A, attribute codes 302a-302c each refer to a single attribute category. In some embodiments, however, an attribute code may refer to a combination of the attribute categories (e.g., by referring to related attribute categories). In one or more embodiments, the attribute code comprises a 1 by N vector, in which N is the number of attributes. Thus, each row in the vector can correspond to an attribute or attribute category. A user can set the row for a desired attribute to a “1” and all other rows to zeros to generate an attribute code for the desired attribute.

Upon receiving an attribute code, the attribute-attention-projection generator 304 generates an attribute attention projection specific to an attribute category, such as by generating an attribute attention projection 306a based on the attribute code 302a. In some embodiments, the attribute-attention-projection generator 304 multiplies the attribute code 302a by a matrix to generate the attribute attention projection 306a. For example, the attribute code 302a may include a separate attribute code for each training image for an iteration. The attribute-attention-projection generator 302 then multiplies the separate attribute code for training image by a matrix, such as an n×2 matrix where n represents the number of training images and 2 represents an initial value for each attribute category.

Additionally, or alternatively, in certain embodiments, the attribute-attention-projection generator 304 comprises an additional neural network separate from the attention controlled neural network 310. For example, the attribute-attention-projection generator 304 may be a relatively simple neural network that receives attribute codes as inputs and produces attribute attention projections as outputs. In some such embodiments, the additional neural network comprises a neural network with a single layer.

The attribute-attention-projection generator 304 may alternatively use a reference or default value for an attribute attention projection to initialize a training process. For instance, in certain embodiments, the attribute-attention-projection generator 304 initializes an attribute attention projection using a default weight or vector for an initial iteration specific to an attribute category. As the attention controlled system 100 back propagates and updates the attribute attention projection and parameters through multiple iterations, the attribute attention projection changes until a point of convergence. For example, in some embodiments, the attribute-attention-projection generator 304 initializes an attribute attention projection to be a weight of one (or some other numerical value) or, alternatively, a default matrix that multiplies an attribute code by one (or some other numerical value).

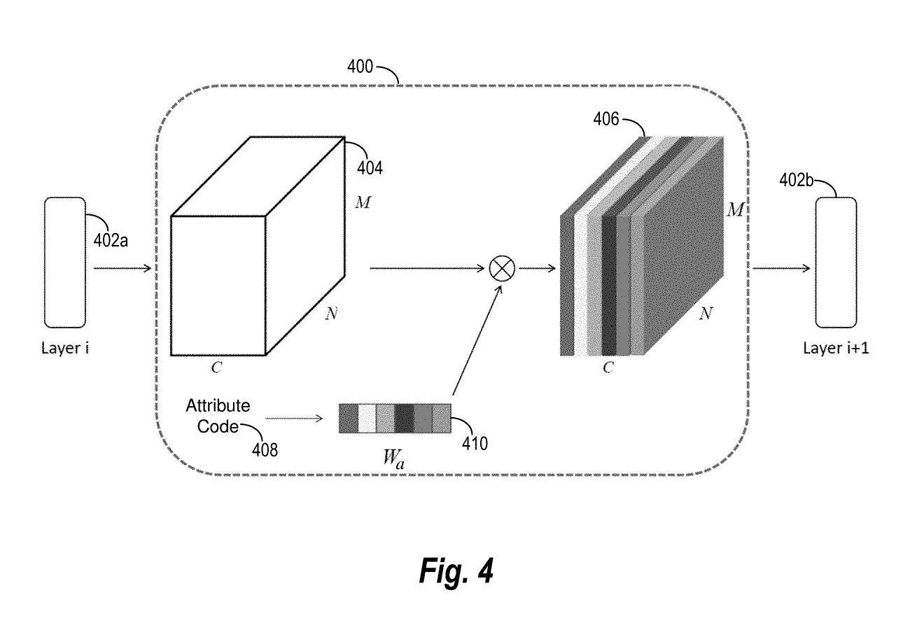

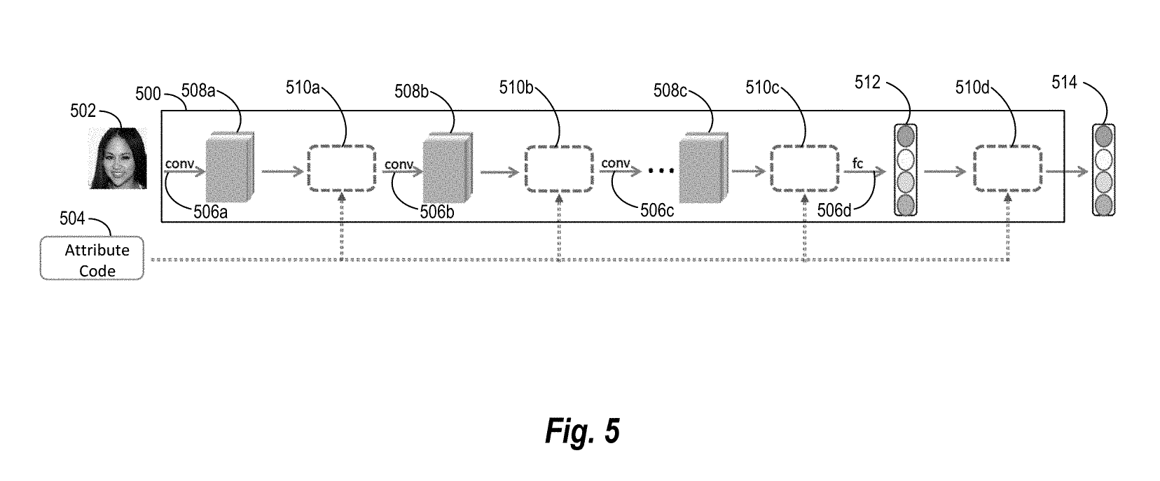

As further shown in FIG. 3A, in addition to generating an attribute attention projection with the attribute-attention-projection generator 304, the attention controlled system 100 inserts the attribute attention projection into the attention controlled neural network 310. In some embodiments, the attention controlled system 100 inserts the attribute attention projection 306a between one or more sets of layers of the attention controlled neural network 310. As discussed below, FIGS. 4 and 5 provide an example of such insertion.

By inserting the attribute attention projection 306a into the attention controlled neural network 310, the attention controlled system 100 uses the attribute attention projection to modulate gradient descent through back propagation. The following function represents an example of how an attribute attention projection Wₐ for an attribute category a modulates gradient descent:

$$∇ θ = {W}_{a} \frac{\partial L}{\partial f} \frac{\partial f}{\partial θ} \qquad ( 3 )$$

According to function (3), when the relationship between images Iᵢ and Iⱼ changes due to a change in attribute categories for a given iteration, Wₐ changes to accommodate the direction from a loss (based on a loss function) to avoid destructive interference.

By changing Wₐ to accommodate the direction from a loss, the attention controlled system 100 effectively modulates a feature f with Wₐ—that is, by using f′=Wₐ f in the following function:

$$∇ θ = \frac{\partial L}{\partial {f}^{′}} {W}_{a} \frac{\partial f}{\partial θ} \qquad ( 4 )$$

Function (4) provides a structure for applying an attribute attention projection. Given the parameter gradient Λθ and input x in a specific layer of the attention controlled neural network 310, the attention controlled system 100 introduces an attribute attention projection Wₐ for an attribute category a to transform Λθ into ΛθO′=WₐΛθ and transform input x into input x′. The attribute attention projection 306a represents one such attribute attention projection Wₐ.

As further shown in FIG. 3A, in addition to inserting the attribute attention projection 306a between layers of the attention controlled neural network 310, the attention controlled system 100 inputs a training image 308a into the attention controlled neural network 310. The attention controlled neural network 310 includes various layers that extract features from the training image 308a. In between some such layers, the attention controlled system 100 applies the attribute attention projection 306a to features extracted from the training image 308a. By applying the attribute attention projection 306a, the attention controlled system 100 generates discriminative features for the training image 308a (e.g., discriminative feature maps). As described below, FIG. 4 provides an example of a discriminative feature map.

Similar to some neural networks, the attention controlled neural network 310 outputs various features from various layers. After extracting features through different layers, the attention controlled neural network 310 outputs an attribute-modulated-feature vector 312a for the training image 308a. Because the attribute-modulated-feature vector 312a is an output of the attention controlled neural network 310, it accounts for features modified by the attribute attention projection 306a. The attention controlled system 100 then uses the attribute-modulated-feature vector 312a in a loss function 314.

Depending on the type of underlying neural network used for the attention controlled neural network 310, the output of the attention controlled neural network 310 can comprise an output other than an attribute-modulated-feature vector. For example, in some embodiments, the attention controlled neural network 310 outputs an attribute modulated classifier (e.g., a value indicating a class of a training image). Additionally, in certain embodiments, the attention controlled neural network 310 outputs an attribute modulated label (e.g., a part-of-speech tag).

As shown in FIG. 3A, the loss function 314 may be any suitable loss function for a given type of neural network. Accordingly, the loss function 314 may include, but is not limited to, a cosine proximity loss function, a cross entropy loss function, Kullback Leibler divergence, a hinge loss function, a mean absolute error loss function, a mean absolute percentage error loss function, a mean squared error loss function, a mean squared logarithmic error loss function, an L1 loss function, an L2 loss function, a negative logarithmic likelihood loss function, a Poisson loss function, a squared hinge loss function, or a triplet loss function.

Regardless of the type of loss function, the attention controlled system 100 uses the loss function 314 to compare the attribute-modulated-feature vector 312a to a reference vector to determine a loss. In some embodiments, the reference vector is an attribute-modulated-feature vector for another training image (e.g., an attribute-modulated-feature vector from another training image in an image triplet). Alternatively, in certain embodiments, the reference vector is an input for the attention controlled neural network 310 that represents a ground truth. But the attention controlled system 100 may use any other reference vector appropriate for the given loss function.

After determining a loss from the loss function, in a training iteration, the attention controlled system 100 back propagates by performing an act 316 of updating an attribute attention projection and performing an act 318 of updating the parameters of the attention controlled neural network 310. When jointly updating an attribute attention projection and neural network parameters, the attention controlled system 100 incrementally adjusts the attribute attention projection and parameters to minimize a loss from the loss function 314. In some such embodiments, in a given training iteration, the attention controlled system 100 adjusts the attribute attention projection and the parameters based in part on a learning rate that controls the increment at which the attribute attention projection and the parameters are adjusted (e.g., a learning rate of 0.01). As shown in the initial training iteration of FIG. 3A, the attention controlled system 100 updates the attribute attention projection 306a and the parameters of the neural network to minimize a loss.

As further shown in FIG. 3A, in addition to generating and updating the attribute attention projection 306a, the attention controlled system 100 generates and updates additional attribute attention projections corresponding to additional attribute categories in further iterations. In particular, in a subsequent training iteration, the attention controlled system 100 uses the attribute-attention-projection generator 304 to generate an attribute attention projection 306b based on an attribute code 302b. Consistent with the disclosure above, the attention controlled system 100 inserts the attribute attention projection 306b into one or more sets of layers of the attention controlled neural network 310 and inputs a training image 308b into the attention controlled neural network 310.

After inputting the training image 308b, the attention controlled neural network 310 analyzes the training image 308b, extracts features from the training image 308b, and applies the attribute attention projection 306b to some (or all) of the extracted features. As part of extracting features from the training image 308b, layers of the attention controlled neural network 310 likewise apply parameters to features of the training image 308b. The attention controlled neural network 310 then outputs an attribute-modulated-feature vector 312b that corresponds to the training image 308b. Consistent with the disclosure above, the attention controlled system 100 determines a loss from the loss function 314 and updates the attribute attention projection 306a and the parameters of the neural network. In a subsequent training iteration, the attention controlled system 100 likewise generates and updates an attribute attention projection 306c using an attribute code 302c, a training image 308c, and an attribute-modulated-feature vector 312c.

In some embodiments, the training images 308a, 308b, and 308c each represent a different set (or batch) of training images. Accordingly, in some training iterations, the attention controlled system 100 updates the attribute attention projection 306a for a particular attribute category by using the training image 308a or other training images from the same set or batch. In other training iterations, the attention controlled system 100 updates the attribute attention projection 306b for a different attribute category by using the training image 308b or other training images from the same set or batch. The same process may be used for updating the attribute attention projection 306c for yet another attribute category any training images from the same set or batch as the training image 308c.

As noted above, in certain embodiments, updated attribute attention projections inherently indicate relationships between one or both of related attribute categories and unrelated attribute categories. For example, as the attention controlled system 100 updates the attribute attention projections 306a and 306b in different iterations, the attribute attention projections 306a and 306b become relatively similar values or values separated by a relatively smaller difference than another pair of attribute attention projections. This relative similarity or relative smaller difference indicates a correlation between the attribute category for the attribute attention projection 306a and the attribute category for the attribute attention projection 306b (e.g., a correlation between a smile in a mouth-expression category and an open mouth in a mouth-configuration category).

Additionally, or alternatively, as the attention controlled system updates the attribute attention projections 306a and 306c, the attribute attention projections 306a and 306c become relatively dissimilar values or values separated by a relatively greater difference than another pair of attribute attention projections. This relative dissimilarity or relative greater difference may indicate a discorrelation between the attribute category for the attribute attention projection 306a and the attribute category for the attribute attention projection 306c (e.g., a discorrelation between a smile in a mouth-expression category and an old face in a face-age category).

Turning now to FIG. 3B, this figure provides an example of training an attention controlled neural network using image triplets and a triplet-loss function. As an overview, the attention controlled system 100 inputs an image triplet into a triplet attention controlled neural network that includes duplicates of an attention controlled neural network. In each training iteration, the attention controlled system 100 determines a triplet loss based on attribute-modulated-feature vectors for the image triplets. Back propagating from the triplet loss, the attention controlled neural network updates both (i) duplicates of an attribute attention projection and (ii) duplicates of parameters within the attention controlled neural networks.

As shown in FIG. 3B, the attention controlled system 100 uses image triplets 320 as inputs for a training iteration. For the initial training iteration, for example, the image triplets 320 include an anchor image 322, a positive image 324, and a negative image 326. In certain embodiments, the anchor image 322 and the positive image 324 both comprise a same attribute corresponding to an attribute category. By contrast, in some embodiments, the negative image 326 comprises a different attribute corresponding to the attribute category. To illustrate, the anchor image 322 and the positive image 324 may both include a face with a smile corresponding to a mouth-expression category, while the negative image 326 includes a face without a smile corresponding to the mouth-expression category. The image triplet of the anchor image 322, the positive image 324, and the negative image 326 may also include attributes that correspond to any other attribute category.

As further shown in FIG. 3B, in an initial training iteration, the attention controlled system 100 uses attribute-attention-projection generators 330a, 330b, and 330c to generate attribute attention projections 332a, 332b, and 332c, respectively. Consistent with the disclosure above, the attribute attention projections 332a, 332b, and 332c are based on attribute codes 328a, 328b, and 328c, respectively. While the anchor image 322, the positive image 324, and the negative image 326 may differ from each other, the attribute codes 328a, 328b, and 328c for a training iteration each correspond to the same attribute category for the image triplet. In other words, the attention controlled system 100 uses duplicates of the same attribute code to generate the same attribute attention projection. In alternative embodiments, a single attribute-attention-projection generator is used.

In addition to generating attribute attention projections, the attention controlled system 100 also inserts the attribute attention projections 332a, 332b, and 332c into duplicate attention controlled neural networks 334a, 334b, and 334c, respectively. The duplicate attention controlled neural networks 334a, 334b, and 334c each include a copy of the same parameters and layers. While the duplicate attention controlled neural networks 334a, 334b, and 334c receive different training images as inputs, the attention controlled system 100 trains the duplicate attention controlled neural networks 334a, 334b, and 334c to learn the same updated parameters through iterative training. Accordingly, the attention controlled system 100 inserts the attribute attention projections 332a, 332b, and 332c between a same set of layers within the duplicate attention controlled neural networks 334a, 334b, and 334c.

As further shown in FIG. 3B, in the same training iteration, the duplicate attention controlled neural networks 334a, 334b, and 334c analyze and extract features from the anchor image 322, the positive image 324, and the negative image 326, respectively. The duplicate attention controlled neural networks 334a, 334b, and 334c then apply the attribute attention projections 332a, 332b, and 332c, respectively, to some (or all) of the extracted features and output attribute-modulated-feature vectors 338, 340, and 342, respectively. The attribute-modulated-feature vectors 338, 340, and 342 correspond to the anchor image 322, the positive image 324, and the negative image 326, respectively.

Having generated attribute-modulated-feature vectors for the image triplet, the attention controlled system 100 determines a triplet loss using a triplet-loss function 336. When applying the triplet-loss function 336, in some embodiments, the attention controlled system 100 determines a positive distance between (i) the attribute-modulated-feature vector 338 for the anchor image 322 and (ii) the attribute-modulated-feature vector 340 for the positive image 324 (e.g., a Euclidean distance). The attention controlled system 100 further determines a negative distance between (i) the attribute-modulated-feature vector 338 for the anchor image 322 and (ii) the attribute-modulated-feature vector 342 for the negative image 326 (e.g., a Euclidean distance). The attention controlled system 100 determines an error when the positive distance exceeds the negative distance by a threshold (e.g., a predefined margin or tolerance).

When back propagating the triplet loss, the attention controlled system 100 determines if updating the attribute attention projections 332a, 332b, and 332c, and the parameters of the duplicate attention controlled neural networks 334a, 334b, and 334c would improve a determined triplet loss. By updating the attribute attention projections 332a, 332b, and 332c, and the parameters, the attention controlled system 100 incrementally minimizes the positive distance between attribute-modulated-feature vectors for positive image pairs (i.e., pairs of an anchor image and a positive image) while simultaneously increasing the negative distance between negative image pairs (i.e., pairs of an anchor image and a negative image).

For example, given an image triplet with attributes corresponding to an attribute category (Iₐ, Iₚ, Iₙ, a)ϵT, in some embodiments, the attention controlled system 100 sums the following functions to determine a triplet loss:

$$\begin{matrix}L = {\sum }_{T} [ {‖ {f}_{a} - {f}_{p} ‖}^{2} + α - {‖ {f}_{a} - {f}_{n} ‖}^{2} ) ] + & ( 5 ) \\ {f}_{a , p , n} = F ( {I}_{a , p , n} \vert θ , {W}_{a} ) ) & ( 6 )\end{matrix}$$

In function (5), α represents an expected distance margin between positive pair and negative pair. Additionally, Iₐ represents the anchor image, Iₚ represents the positive image, and Iₙ represents the negative image corresponding to an attribute category a. As shown by function (6), the attribute-modulated-feature vector “f” for each of the anchor image, the positive image, and the negative image are a function of the neural network “θ” and the attribute attention projection Wₐ. As the attention controlled system 100 updates the attribute attention projection Wₐ, the duplicate attention controlled neural networks learn knobs to decouple unrelated attribute categories and correlate related attribute categories to minimize the triplet loss.

As suggested above, in additional training iterations, the attention controlled system 100 optionally uses image triplets corresponding to additional attribute codes for additional attribute categories. By using image triplets for multiple attribute categories, the attention controlled system 100 learns attribute attention projections for different attribute categories. Accordingly, consistent with the disclosure above, in subsequent training iterations indicated in FIG. 3B, the attention controlled system 100 generates and updates additional attribute attention projections using additional attribute codes, training triplets, and attribute-modulated-feature vectors. In each such training iteration, the attention controlled system 100 further back propagates a triplet loss to update an additional attribute attention projection and the parameters for the duplicate attention controlled neural networks 334a, 334b, and 334c.

In addition (or in the alternative) to the image triplets described above, in some embodiments, the attention controlled system 100 uses image triplets that include so-called hard positive cases and hard negative cases. In such embodiments, the positive distance between feature vectors of the anchor image and the positive image is relatively far apart, while the negative distance between the feature vectors of the anchor image and the negative image is relatively close together.

As illustrated by the discussion above, the attention controlled system 100 jointly learns the attribute attention projections and the parameters of the attention controlled neural network. In particular, in a given training iteration, the attention controlled system 100 jointly updates an attribute attention projection and the parameters of the attention controlled neural network. In a subsequent iteration, the attention controlled system 100 jointly updates a different attribute attention projection and the same parameters of the attention controlled neural network.

The algorithms and acts described in reference to FIG. 3A comprise the corresponding acts for a step for training an attention controlled neural network to generate attribute-modulated-feature vectors using attribute attention projections for attribute categories. Moreover, the algorithms and acts described in reference to FIG. 3B comprise the corresponding acts for a step for training an attention controlled neural network via triplet loss to generate attribute-modulated-feature vectors using attribute attention projections for attribute categories.

As suggested above, in some embodiments, the attention controlled system 100 inserts and applies an attribute attention projection between one or more sets of layers of the attention controlled neural network. When inserting or applying such an attribute attention projection, the attention controlled system 100 optionally uses a gradient modulator. FIG. 4 illustrates one such gradient modulator. The gradient modulator adapts features via learned weights with respect to each attribute or task.

As shown in FIG. 4, the attention controlled system 100 uses a gradient modulator 400 between a first layer 402a and a second layer 402b of an attention controlled neural network. The gradient modulator 400 generates an attribute attention projection 410 based on an attribute code 408 and applies the attribute attention projection 410 to a feature map 404 generated by the first layer 402a. By applying the attribute attention projection 410 to the feature map 404, the gradient modulator 400 generates a discriminative feature map 406. As used in this disclosure, the term “discriminative feature map” refers to a feature map modified by an attribute attention projection to focus or weight features corresponding to an attribute category. As shown, the first layer 402a outputs the feature map 404, and (after application of the attribute attention projection 410) the second layer 402b receives the discriminative feature map 406 as an input.

As depicted in FIG. 4, the feature map 404 has a size represented by dimensions M*N and a number of feature channels represented by C. To match these dimensions and channels, the attention controlled system 100 generates an attribute attention projection 410 comprising a size of MNC*MNC. In this particular embodiment, the attribute attention projection is a channel-wise scaling vector that preserves the size of the feature to which it applies. By using the attribute attention projection 410 with such dimensions, the gradient modulator 400 keeps the discriminative feature map 406 the same size as the feature map 404. Accordingly, as shown in FIG. 4, the discriminative feature map 406 likewise has a size represented by dimensions M*N and a number of feature channels represented by C.

Because the attribute attention projection 410 does not alter the size of the feature map 404, the gradient modulator 400 can be used in any existing neural-network architecture. In other words, the attention controlled system 100 can transplant the gradient modulator 400 into any type of neural network and train the neural network to become an attention controlled neural network. The gradient modulator provides a level of flexibility to any neural network existing neural network.

While FIG. 4 illustrates an attribute attention projection in between one set of layers, in some embodiments, the attention controlled system 100 inserts multiple copies of an attribute attention projection between multiple sets of layers. FIG. 5 illustrates an attention controlled neural network 500 that includes multiple gradient modulators. In particular, the attention controlled neural network 500 is a fully modulated attention controlled neural network because it includes a gradient modulator in between each of the network's layers.

As shown in FIG. 5, the attention controlled neural network 500 includes a first convolutional layer 506a, a second convolutional layer 506b, a third convolutional layer 506c, and a fourth fully-connected layer 506d. The attention controlled system 100 inserts several gradient modulators between different layer sets—a first gradient modulator 510a in between the first convolutional layer 506a and the second convolutional layer 506b, a second gradient modulator 510b in between the second convolutional layer 506b and the third convolutional layer 506c, and a third gradient modulator 510c in between the third convolutional layer 506c and the fourth fully-connected layer 506d. The attention controlled system 100 also optionally inserts a fourth gradient modulator 510d after the fourth fully-connected layer 506d. Note that in this optional embodiment, the fourth gradient modulator 510d is not between layers but is a back-end modulator. Each of the gradient modulators 510a-510d use a copy of an attribute attention projection that the attention controlled system 100 generates based on attribute code 504.

As FIG. 5 suggests, the attention controlled system 100 inputs an image 502 into the attention controlled neural network 500. Consistent with the disclosure above, the attention controlled neural network 500 extracts features layer by layer. In particular, the first convolutional layer 506a, the second convolutional layer 506b, and the third convolutional layer 506c extract a first feature map 508a, a second feature map 508b, and a third feature map 508c, respectively. The gradient modulators then modulate the feature maps. In particular, the first gradient modulator 510a, the second gradient modulator 510b, and the third gradient modulator 510c respectively apply an attribute attention projection to the first feature map 508a, the second feature map 508b, and the third feature map 508 to generate discriminative feature maps (not shown). Similarly, the fourth gradient modulator 510d applies the attribute attention projection to a feature vector 512 output by the fourth fully-connected layer 506d to create an attribute-modulated-feature vector 514.

In some embodiments, a modulate attention controlled neural network 500 uses channel-wise scaling vectors as attribute attention projections, where W={w_{c}}, cϵ{1, . . . , C}. As the attention controlled neural network applies the attribute attention projection to feature maps, the gradient modulators output discriminative feature maps represented by the following function:

x_{mnc}′=x_{mnc}′w_{c} (7)

In function (7), x_{mnc}′ and x_{mnc}′w_{c} represent elements from input and output feature maps, respectively. For simplicity, function (7) does not include further representation of a with superscription notation to represent the relevant attribute category.

In the alternative to using channel-wise scaling vectors as attribute attention projections, in some embodiments, the attention controlled system 100 uses channel-wise projection matrixes in the attention controlled neural network, where W={w_{i,j}},{i,j}ϵ{1, . . . , C}. In this particular embodiment, as the attention controlled neural network applies the attribute attention projection to feature maps, the gradient modulators output discriminative feature maps represented by the following function:

$${x}_{mnc}^{′} = {\sum }_{{c}^{′}} {x}_{{mnc}^{′}} {w}_{{cc}^{′}} \qquad ( 8 )$$

In function (8), x_{mnc}′ and x_{mnc}′w_{cc}′ represent elements from input and output feature maps, respectively.

While the attention controlled neural network 500 of FIG. 5 includes five layers, as noted above, the attention controlled system 100 may use any suitable neural network. For example, in some embodiments, the attention controlled neural network comprises the architecture shown in Table 1 below:

TABLE 1

| Name | Operation | Output Size |
|---|---|---|
| Conv1 | 3 × 3 convolution | 148 × 148 × 32 |
| Block2 | Conv-Pool-ResNetBlock | 73 × 73 × 64 |
| Block3 | Conv-Pool-ResNetBlock | 35 × 35 × 128 |
| Block4 | Conv-Pool-ResNetBlock | 16 × 16 × 128 |
| Block5 | Conv-Pool-ResNetBlock | 7 × 7 × 128 |
| FC | Fully-Connected | 256 |

In the Table 1 above, Conv-Pool-ResNetBlock represents a 3×3 convolutional layer followed by a stride 2 pooling layer and a standard residual block consisting of two 3×3 convolutional layers. In one or more embodiments employing such a neural network, the attention controlled system 100 can insert the gradient modulators after Block4, Block5, and the fully connected layers. The neural network represented by Table 1 above comprises a relatively simple neural network yet when modulated, the neural network represented by Table 1 above provides improved accuracy over more complex conventional neural networks.

The algorithms and acts described in reference FIG. 4 comprise the corresponding acts for a step for generating an attribute-modulated-feature vector for a digital input image using an attribute attention projection and the trained attention controlled neural network.

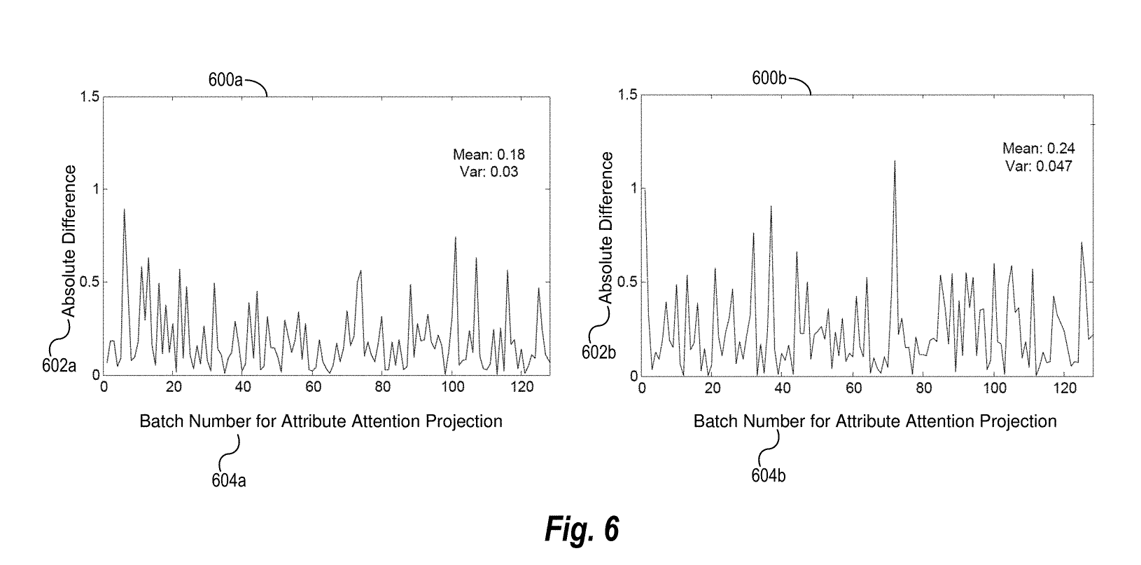

As the attention controlled system 100 trains an attention controlled neural network, in certain embodiments, attribute attention projections for related attribute categories become relatively similar compared to attribute attention projections for unrelated attribute categories. FIG. 6 depicts a graph 600a showing differences between two attribute attention projections corresponding to related attribute categories. FIG. 6 also depicts a graph 600b showing differences between two attribute attention projections corresponding to unrelated attribute categories during training.

As shown in FIG. 6, the graph 600a includes a vertical axis 602a and a horizontal axis 604a. The vertical axis 602a represents an absolute difference between a first attribute attention projection and a second attribute attention projection. In this particular embodiment, the first and second attribute attention projections comprise numerical values (e.g., numerical weights). Whereas the first attribute attention projection corresponds to a first attribute category, the second attribute attention projection corresponds to a second attribute category. For example, the first attribute attention projection may correspond to a mouth-expression category (with attributes for smile and no smile), and the second attribute attention projection may correspond to a mouth-configuration category (with attributes for open mouth and closed mouth). Relatedly, the horizontal axis 604a represents the batch numbers for the first and second attribute attention projections during training. Each batch number represents multiple training iterations.

Similarly, the graph 600b includes a vertical axis 602b and a horizontal axis 604b. The vertical axis 602b represents an absolute difference between the first attribute attention projection and a third attribute attention projection. Here again, the first and third attribute attention projections are numerical values (e.g., numerical weights). The third attribute attention projection corresponds to a third attribute category, such as a face age category (with attributes for young face and old face). The horizontal axis 604b represents the batch numbers for the first and second attribute attention projections during training. Again, each batch number represents multiple training iterations.

As indicated by the graphs 600a and 600b, the absolute difference between the first and second attribute attention projections is relatively smaller than the absolute difference between the first and third attribute attention projections. Throughout training, the absolute difference between the first and second attribute attention projections has a mean of 0.18 with a variance of 0.03. By contrast, the absolute difference between the first and third attribute attention projections has a mean of 0.24 and a variance of 0.047. Collectively, the relative similarity between the first and second attribute attention projections indicates a correlation between the first attribute category and the second attribute category. The relative dissimilarity of the first and third attribute attention projections indicates a discorrelation between the first attribute category and the third attribute category.

In addition to learning attribute attention projections that indicate correlations or discorrelations, in some embodiments, the attention controlled system 100 regularizes attribute attention projections for pairs of related attribute categories to have similar values by using a variation of a loss function. For example, in some embodiments, the attention controlled system 100 uses the following loss function:

Lₐ=max(0,∥Wᵢ−Wⱼ∥²+β−|Wᵢ−Wₖ∥²) (9)

In function (9), β represents an expected distance margin, and i, j, and k represent different attribute categories. Based on prior assumptions, the attention controlled system 100 considers the attribute-category pair (i, j) to be more related (or correlative) than the attribute-category pair (i, k). As also shown in function (9), Lₐ represents a loss that is weighted by a hyper-parameter λ and combined with a triplet loss from feature vectors of image triplets in training, such as from function (4). In experiments, the regularization loss from function (9) produces marginally better accuracy than the loss from function (5) by itself.

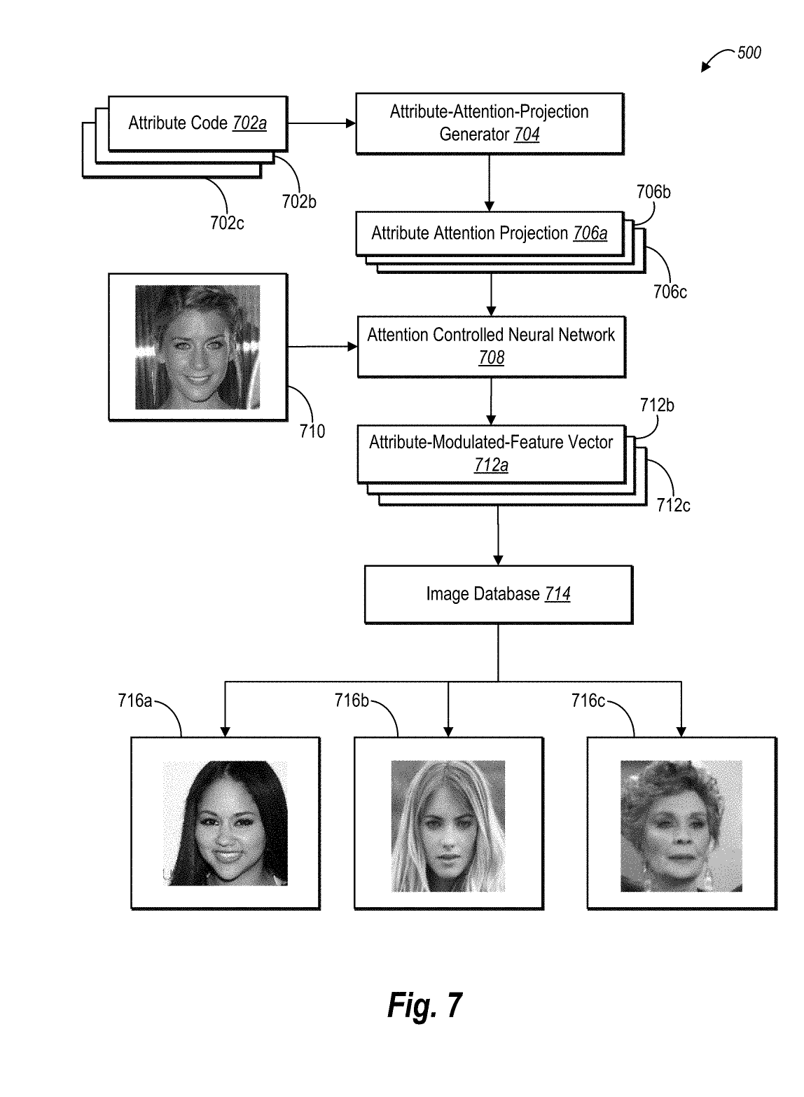

The attention controlled system 100 uses an attribute attention projection within an attention controlled neural network to generate an attribute-modulated-feature vector for a task. FIG. 7 illustrates embodiments of the attention controlled system 100 using a trained attention controlled neural network. As an overview, the attention controlled system 100 generates an attribute attention projection based on an attribute code and inserts the attribute attention projection into the attention controlled neural network. The attention controlled neural network then applies the attribute attention projection (and parameters) to certain features extracted from a digital input image to generate an attribute-modulated-feature vector. The attention controlled system 100 then performs a task based on the attribute-modulated-feature vector.

As shown in FIG. 7, the attention controlled system 100 inputs an attribute code 702a into an attribute-attention-projection generator 704. The attribute code 302a corresponds to an attribute category for a digital input image 710. Consistent with the disclosure above, the attribute-attention-projection generator 704 generates an attribute attention projection based on the attribute code 302a. Because the attention controlled system 100 learns attribute attention projections for particular attribute categories, in certain embodiments, the attribute-attention-projection generator 704 generates the attribute attention projection 706a that the attention controlled system 100 learned during training for a particular attribute category.

The attention controlled system 100 further inserts the attribute attention projection 706a into an attention controlled neural network 708 for application. Consistent with the disclosure above, the attention controlled system 100 inserts one or more copies between one or more sets of layers of the attention controlled neural network 708. As in certain embodiments above, the attention controlled neural network 708 may be, but is not limited to, any of the neural network types mentioned above, such as a feedforward neural network, a modular neural network, a radial basis neural network, a regulatory feedback neural network, or a recurrent neural network.

As further shown in FIG. 7, the attention controlled system 100 inputs a digital input image 710 into the attention controlled neural network 708. The attention controlled neural network 708 then analyzes the digital input image 710, extracts features from the digital input image 710, and applies the attribute attention projection 706a to some (or all) of the layers of the attention controlled neural network 708. As part of extracting features from the digital input image 710, layers of the attention controlled neural network 708 likewise apply parameters to features of the digital input image 710.

As part of using a trained version of the attention controlled neural network 708, in some embodiments, the attention controlled system 100 applies the attribute attention projection 706a to a feature map between one or more sets of layers of the attention controlled neural network 708. By applying the attribute attention projection to a feature map, the attention controlled system 100 generates a discriminative feature map. For example, in certain embodiments, the attention controlled system 100 applies the attribute attention projection 706a and/or uses a gradient modulator as described above with reference to FIGS. 4 and 5.

As shown in FIG. 7, the attention controlled neural network 310 also outputs an attribute-modulated-feature vector 712a that corresponds to the digital input image 710. Based on the attribute-modulated-feature vector 712a, the attention controlled system 100 performs a task. For example, based on the attribute-modulated-feature vector 712a, the attention controlled system 100 may identify an object within the digital input image 710, produce a word or phrase describing the digital input image 710, or retrieve an output digital image corresponding to the digital input image 710. The foregoing tasks are merely examples. In application, the attention controlled system 100 may perform any task suitable for the underlying type of neural network for the attention controlled neural network 708.

As noted above, in some embodiments, an attention controlled neural network generates an attributed modulated feature other than an attribute-modulated-feature vector. In such embodiments, the attention controlled system 100 performs a task based on the generated attention modulated feature (e.g., an attribute modulated classifier or attribute modulated label).

As shown in FIG. 7, the attention controlled system 100 retrieves output digital images corresponding to the digital input image 710. In particular, the attention controlled system 100 compares the attribute-modulated-feature vector 712a to feature vectors of images within an image database 714. For example, the attention controlled system 100 searches the image database 714 for images within the image database 714 corresponding to a feature vector most similar to the attribute-modulated-feature vector 712a (e.g., images having a feature vector with the lowest distance or lowest average distance from the attribute-modulated-feature vector 712a). As FIG. 7 indicates, the attention controlled system 100 identifies and retrieves digital output images 716a, 716b, and 716c from among digital images within the image database 714.

In the embodiment depicted in FIG. 7, the attention controlled system 100 identifies the digital output images 716a, 716b, and 716c as the digital images within the image database 712 corresponding to feature vectors most similar to the attribute-modulated-feature vector 712a. Based on the similarity between the feature vectors for the digital output images 716a, 716b, and 716c, on the one hand, and the attribute-modulated-feature vector for the digital input image 710, on the other hand, the attention controlled system 100 determines that the digital output images 716a, 716b, and 716c include attributes from an attribute category similar to a corresponding attribute of the digital input image 710. Here, the attention controlled system 100 retrieves the digital output images 716a, 716b, and 716c because the corresponding feature vectors indicate that they include a facial feature (e.g., a smile) similar to a facial feature within the digital input image 710.

In addition to performing a task based on a single attribute-modulated-feature vector, in some embodiments, the attention controlled system 100 generates and uses multiple attribute attention projections to generate multiple attribute-modulated-feature vectors for a digital input image. By using multiple attribute attention projections and attribute-modulated-feature vectors, the attention controlled system 100 may perform a task based on multiple attribute-modulated-feature vectors corresponding to different attributes of a digital input image. Alternatively, the attention controlled system 100 may perform multiple tasks each based on a different attribute-modulated-feature vector that corresponds to a different attribute for a digital input image.

As shown in FIG. 7, for example, the attention controlled system 100 generates the attribute attention projection 706a based on the attribute code 702a for use in a first iteration of inputting the digital input image 710 into the attention controlled neural network 708. Additionally, the attention controlled system 100 uses the attribute-attention-projection generator 704 to generate an attribute attention projection 706b based on an attribute code 702b for use in a second iteration of inputting the digital input image 710. Similarly, the attention controlled system 100 uses the attribute-attention-projection generator 704 to generate an attribute attention projection 706c based on an attribute code 702c for use in a third iteration of inputting the digital input image 710.

In some embodiments, the attention controlled system 100 inputs the digital input image 710 into the attention controlled neural network 708 during multiple iterations to generate multiple attribute-modulated-feature vectors. As described above, in the first iteration, the attention controlled system inserts the attribute attention projection 706a (and inputs the digital input image 710) into the attention controlled neural network 708 to generate the attribute-modulated-feature vector 712a. In the second iteration, the attention controlled system inserts the attribute attention projection 706b (and inputs the digital input image 710) into the attention controlled neural network 708 the attention controlled neural network 708 to generate the attribute-modulated-feature vector 712b. Similarly, in the third iteration, the attention controlled system inserts the attribute attention projection 706c (and inputs the digital input image 710) into the attention controlled neural network 708 to generate the attribute-modulated-feature vector 712c.

After generating the attribute-modulated-feature vectors 712a, 712b, and 712c individually or collectively, in certain embodiments, the attention controlled system 100 performs multiple tasks respectively based on the attribute-modulated-feature vectors 712a, 712b, and 712c. For example, in some embodiments, the attention controlled system 100 retrieves a first set of digital output images corresponding to the digital input image 710 based on the attribute-modulated-feature vector 712a; a second set of digital output images corresponding to the digital input image 710 based on the attribute-modulated-feature vector 712b; and a third set of digital output images corresponding to the digital input image 710 based on the attribute-modulated-feature vector 712c.

In addition to performing multiple tasks, after generating the attribute-modulated-feature vectors 712a, 712b, and 712c, the attention controlled system 100 optionally performs a task based on a combination of the attribute-modulated-feature vectors 712a, 712b, and 712c. For example, in certain embodiments, the attention controlled system 100 determines an average for attribute-modulated-feature vectors 712a, 712b, and 712c and identifies images from among the image database 714 having feature vectors most similar to the average for the attribute-modulated-feature vectors 712a, 712b, and 712c. In some such embodiments, the attention controlled system 100 identifies images having feature vectors having a smallest distance from the average for the attribute-modulated-feature vectors 712a, 712b, and 712c.

Alternatively, in some embodiments, the attention controlled system 100 identifies and ranks images from the image database 714 having feature vectors similar to each of the attribute-modulated-feature vectors 712a, 712b, and 712c. The attention controlled system 100 then identifies digital images from among the ranked images having the highest combined (or average) ranking as output digital images. Regardless of the method used to identify digital output images, in some embodiments, the attention controlled system 100 retrieves, reproduces, or sends the digital output images for a client device to present.

As an example use case, the attention controlled system 100 can generate an attribute-modulated-feature vector 712a for a smile, an attribute-modulated-feature vector 712b for open mouth, and an attribute-modulated-feature vector 712c for young. The attention controlled system 100 can then retrieve the images from the image database 714 that have feature vectors that correspond or match most with the attribute-modulated-feature vectors 712a, 712b, and 712c (e.g., an average of the attribute-modulated-feature vectors 712a, 712b, and 712c or the smallest combined distance from each of the attribute-modulated-feature vectors 712a, 712b, and 712c). In other words, the attention controlled system 100 identifies images from the image database 714 that include a person of a similar age, similar smile, and similar amount of open-mouth as the digital input image 710. In other words, the attention controlled system 100, when performing a retrieval task, can focus on attributes of an input digital image identified by the attribute code.

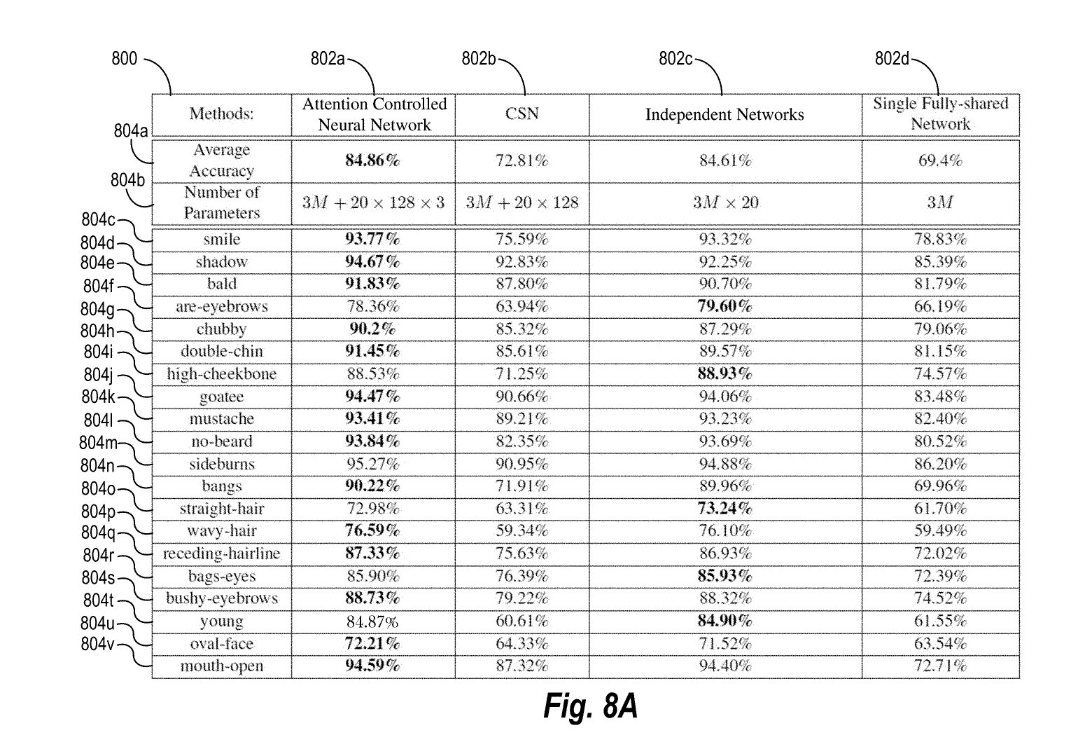

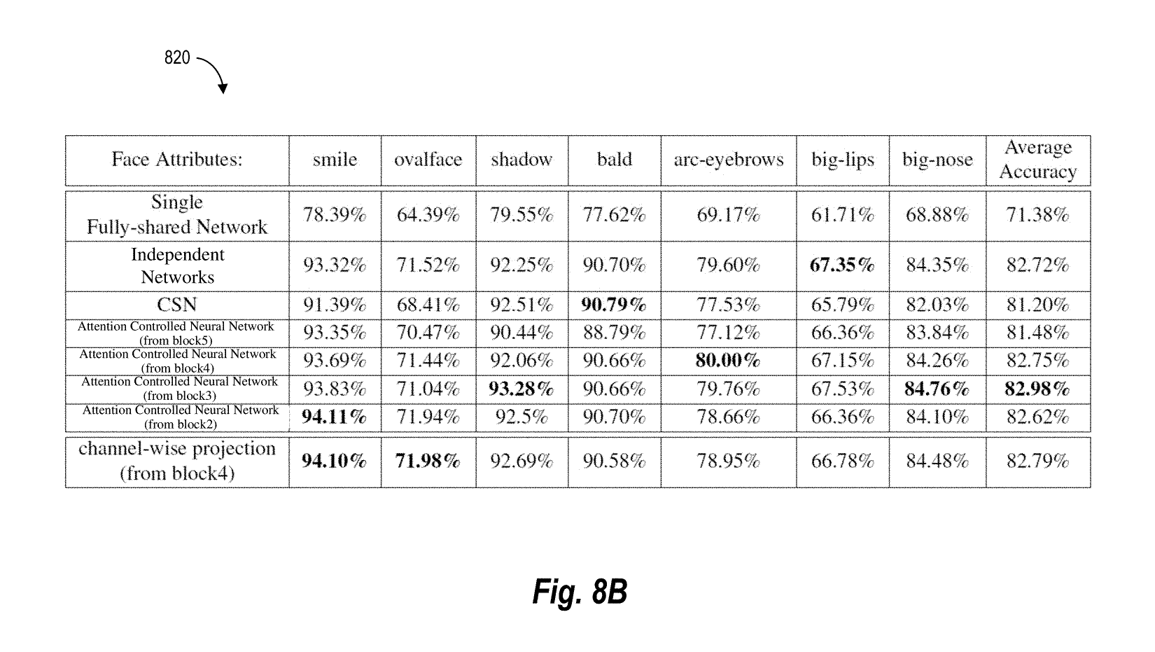

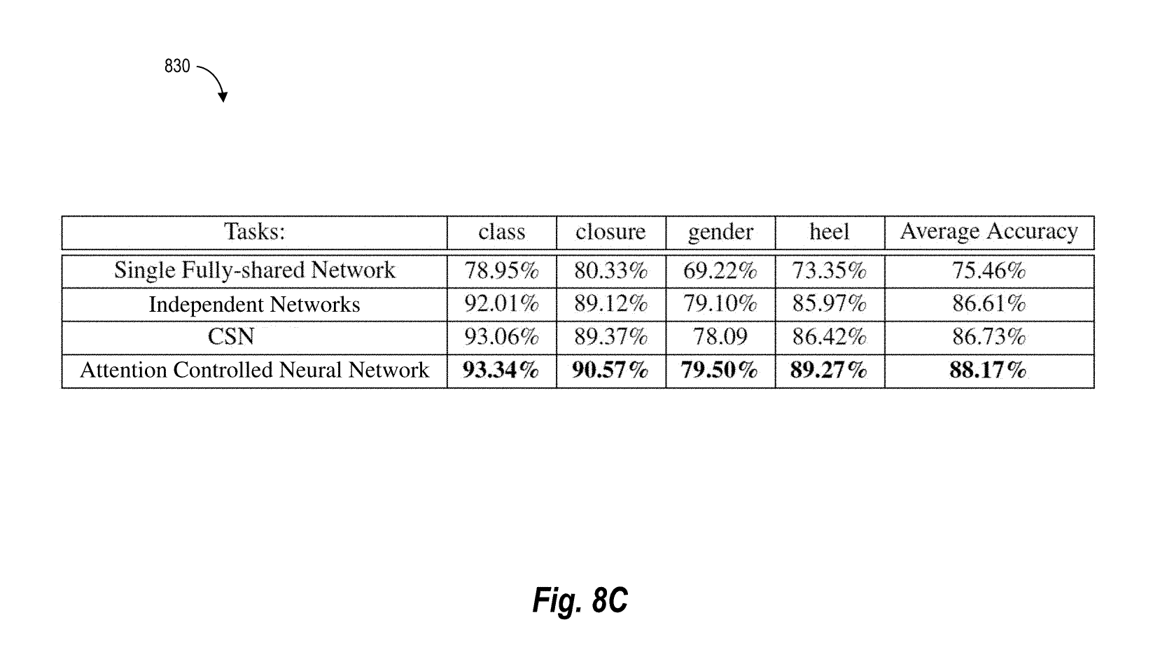

As noted above, in certain embodiments, the attention controlled system 100 allows for retrieval of images that can focus on an attribute(s) from an input digital image in a more accurate manner than even state of the art conventional systems. FIG. 8A depicts a table 800 that compares the accuracy of the attention controlled system 100 in performing an image retrieval task compared to conventional systems

As indicated by FIG. 8A, the attention controlled system 100 trains an attention controlled neural network using attribute attention projections corresponding to twenty different attribute categories. During training and application, the attention controlled system uses an attention controlled neural network with the architecture described in the Table 1 above and with gradient modulators inserted after Block4, after Block5, and after the fully connected layer. Using updated attribute attention projections learned during training and attribute-modulated-feature vectors, the attention controlled system 100 retrieves digital output images corresponding to various digital input images with a focus on attribute(s) indicated in the table. As indicated by column 802a and row 804a of the table 800, the attention controlled system 100 accurately retrieves a digital output image an average of 84.86% with an attribute from twenty different attribute categories corresponding to an attribute of a digital input image.

For comparison, experimenters likewise retrieve digital output images corresponding to digital input images using three existing neural networks. First, the experimenters use a Conditional Similarity Network (“CSN”) described by A. Veit, S. Belongie, and T. Karalestsos, “Conditional Similarity Networks,” Computer Vision and Pattern Recognition (2017). The CSN was trained to identify attributes for the same twenty attribute categories. Second, the experimenters use neural networks each independently trained to identify an attribute from one of the same twenty attribute categories. Third, the experimenters use a Single Fully-Shared Network trained to identify attributes for the same twenty attribute categories.

As indicated by row 804a and columns 802a, 802b, 802c, and 802d of the table 800, on average, the attention controlled system 100 more accurately retrieves digital output images with attributes (from the twenty different attribute categories) corresponding attributes of digital input images than the CSN, independently trained neural networks, and the Single Fully-Shared Network. As indicated in row 804b, the attention controlled system 100 uses an attention controlled neural network with fewer parameters than the CSN, independently trained neural networks, and the Single Fully-Shared Network. Despite having fewer parameters, the attention controlled neural network demonstrates better accuracy than the existing neural networks.

As further shown in rows 804d-804v of the table 800, the attention controlled system 100 more accurately retrieves digital output images with attributes (from fifteen of the twenty attribute categories) corresponding attributes of digital input images than the CSN, independently trained neural networks, and the Single Fully-Shared Network. Rows 804d-804v of the table 800 also indicate that the accuracy of the CSN and Single Fully-Shared Network decline significantly with twenty attribute categories due to destructive interference.

FIG. 8B illustrates a table 820 that shows an evaluation of performance of the attention controlled system described above in relation to FIG. 8A when more gradient modulators are inserted in the attention controlled neural network. As shown, adding gradient modulators into all layers after block N, N=5, 4, 3, 2, improves the performance. This illustrates that the more layers are modulated, the more the effects of destructive interference are minimized. Because early layers in the neural network generally learn primitive features shared across a broad spectrum, shared parameters many not suffer from conflicting gradients. Thus, the performance improvement eventually saturates.

FIG. 8B also shows the results of an experiment with a channel-wise projection matrix instead of a channel-wise scaling vector as the attention controlled projection. As shown in the last row of table 820, the more complicated attention controlled projection provides a marginal improvement. This suggests that potentially with more parameters being modulated, the overall performance improves at a cost of additional task-specific parameters. The results of the last row of table 820 also show that a channel-wise scaling vector as the attention controlled projection is a cost-effective choice.

While the example implementations of the attention controlled system described above all concern image retrieval for faces, one will appreciate that the attention controlled system is flexible and can provide improvement to various tasks. As an example of the flexibility of the attention controlled system, experimenters performed an image retrieval task for products. As indicated by the table 830 of FIG. 8C, the attention controlled system 100 trains an attention controlled neural network using attribute attention projections corresponding to four different attribute categories (i.e., class, closure, gender, and heel) of a product (i.e., shoes). During training and application, the attention controlled system uses an attention controlled neural network with the architecture described in the Table 1 above and with gradient modulators inserted after Block4, after Block5, and after the fully connected layer. Using updated attribute attention projections learned during training and attribute-modulated-feature vectors, the attention controlled system 100 retrieves digital output images of products corresponding to various digital input images of products with a focus on attribute(s) indicated in the table 830.

For comparison, experimenters likewise retrieve digital output images corresponding to digital input images using three existing neural networks. First, the experimenters use a CSN. The CSN was trained to identify attributes for the same four attribute categories. Second, the experimenters use neural networks each independently trained to identify an attribute from one of the same four attribute categories. Third, the experimenters use a Single Fully-Shared Network trained to identify attributes for the same four attribute categories.

As shown by table 830, the attention controlled system 100 more accurately retrieves digital output images with attributes than the CSN, independently trained neural networks, and the Single Fully-Shared Network. Furthermore, the attention controlled system 100 provides the significantly better results despite using a simpler network and not having to pre-train on ImageNet like the state of the art CSN.

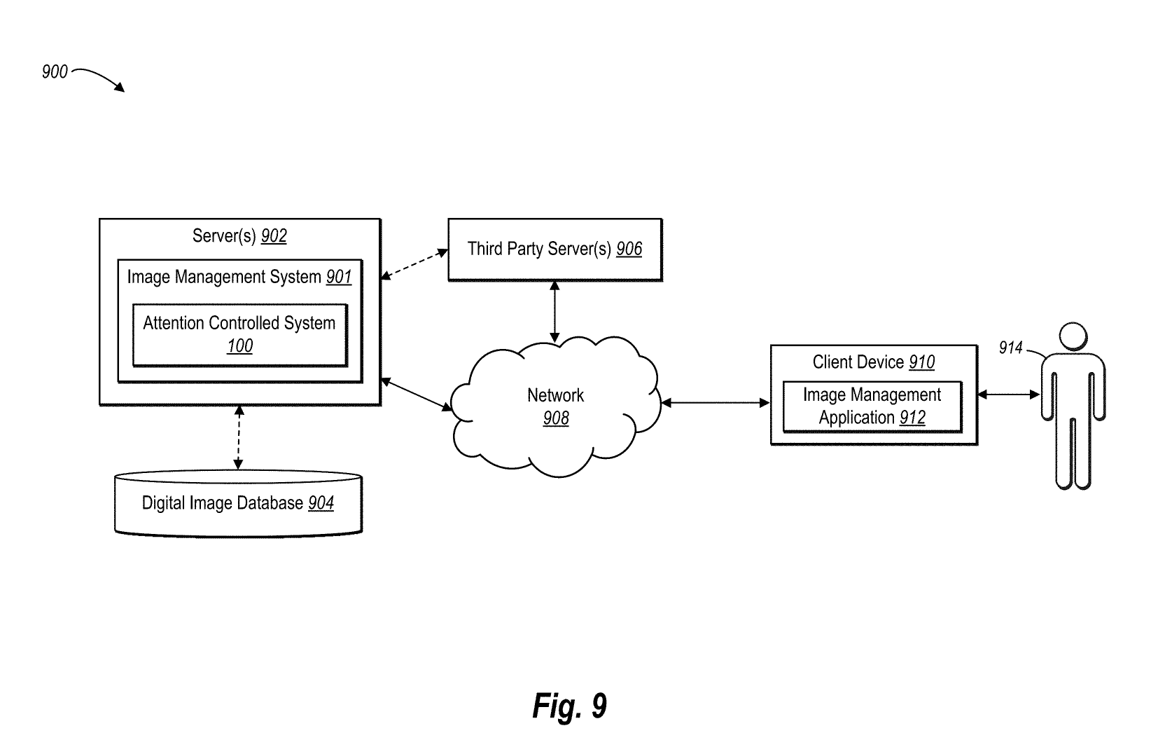

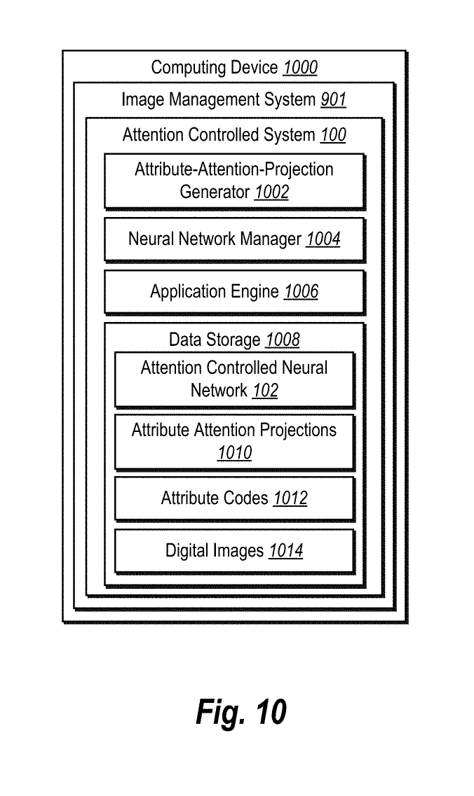

Turning now to FIGS. 9 and 10, these figures provide an overview of an environment in which an attention controlled system can operate and an example of an architecture for the attention controlled system. FIG. 9 is a block diagram illustrating an environment 900 in which the attention controlled system 100 can operate in accordance with one or more embodiments. As illustrated in FIG. 9, the environment 900 includes server(s) 902; a client device 910; a user 914; and a network 908, such as the Internet. The server(s) 902 can host an image management system 901 that includes the attention controlled system 100. The image management system 901, in general, facilitates the creation, modification, sharing, accessing, storing, and/or deletion of digital content (e.g., digital images or digital videos). As shown in FIG. 9, the attention controlled system 100 comprises computer executable instructions that, when executed by a processor of the server(s) 902, perform certain actions described above with reference to FIGS. 1-8C.

Although FIG. 9 illustrates an arrangement of the server(s) 902, the client device 910, and the network 908, various additional arrangements are possible. For example, the client device 910 may directly communicate with the server(s) 902 and thereby bypass the network 908. Alternatively, in certain embodiments, the client device 910 includes and executes computer-executable instructions that comprise the attention controlled system 100. For explanatory purposes, however, the disclosure in relation to FIG. 9 describes the server(s) 902 as including and executing the attention controlled system 100.

As further illustrated in FIG. 9, the client device 910 communicates through the network 908 with the attention controlled system 100 via the server(s) 902. Accordingly, the user 914 can access one or more digital images, digital documents, or software applications provided (in whole or in part) by the attention controlled system 100, including to download data packets encoding for an image management application 912. Additionally, in some embodiments, third party server(s) 906 provide data to the server(s) 902 that enable the attention controlled system 100 to access, download, or upload digital images or digital documents via the server(s) 902.

As also shown in FIG. 9, in some embodiments, the attention controlled system 100 accesses, manages, analyzes, and queries data corresponding to digital images or other digital documents, such as when inputting a digital image into the attention controlled neural network 102. For example, the attention controlled system 100 accesses and analyzes digital images that are stored within the digital image database 904. In some such embodiments, upon accessing a digital image or receiving a digital image, the attention controlled system 100 identifies an attribute code for the digital image, generates an attribute attention projection, and inputs the digital image into the attention controlled neural network.

To access the functionalities of the attention controlled system 100, in certain embodiments, the user 914 interacts with the image management application 912 on the client device 910. In some embodiments, the image management application 912 comprises a web browser, applet, or other software application (e.g., native application) available to the client device 910. Additionally, in some instances, the attention controlled system 100 provides data packets including instructions that, when executed by the client device 914, create or otherwise integrate the image management application 912 within an application or webpage. While FIG. 9 illustrates one client device and one user, in alternative embodiments, the environment 900 includes more than the client device 910 and the user 914. For example, in other embodiments, the environment 900 includes hundreds, thousands, millions, or billions of users and corresponding client devices.

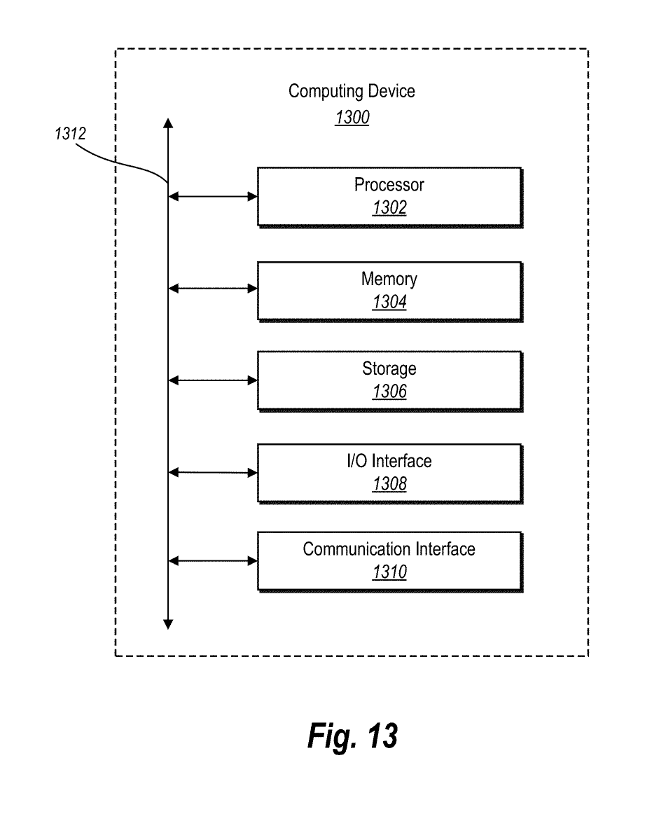

In one or more embodiments, the client device 910 transmits data corresponding to a digital image or digital document through the network 908 to the attention controlled system 100, such as when downloading digital images, digital documents, or software applications or uploading digital images or digital documents. To generate the transmitted data or initiate communications, the user 914 interacts with the client device 910. The client device 910 may include, but is not limited to, mobile devices (e.g., smartphones, tablets), laptops, desktops, or any other type of computing device, such as those described below in relation to FIG. 13. Similarly, the network 908 may comprise any of the networks described below in relation to FIG. 13.

As noted above, the attention controlled system 100 may include instructions that cause the server(s) 902 to perform actions for the attention controlled system 100 described above. For example, in some embodiments, the server(s) 902 execute such instructions by generating an attribute attention projection for an attribute category of training images, using an attention controlled neural network to generate an attribute-modulated-feature vector for a training image from the training images, and jointly learns an updated attribute attention projection and updated parameters of the attention controlled neural network 102 to minimize a loss from a loss function. Additionally, or alternatively, in some embodiments, the server(s) 902 execute such instructions by generating an attribute attention projection based on an attribute code for an attribute category of a digital input image, uses the attention controlled neural network 102 to generate an attribute-modulated-feature vector for the digital input image, and perform a task based on the attribute-modulated-feature vector.

As also illustrated in FIG. 9, the image management system 901 is communicatively coupled to a digital image database 904. In one or more embodiments, the image management system 901 accesses and queries data from the digital image database 904 associated with requests from the attention controlled system 100. For instance, the image management system 901 may access digital images or digital documents for the attention controlled system 100. As shown in FIG. 9, the digital image database 904 is separately maintained from the server(s) 902. Alternatively, in one or more embodiments, the image management system 901 and the digital image database 904 comprise a single combined system or subsystem within the server(s) 902.

Turning now to FIG. 10, this figure provides additional detail regarding components and features of the attention controlled system 100. In particular, FIG. 10 shows a computing device 1000 implementing the image management system 901 and the attention controlled system 100. In some embodiments, the computing device 1000 comprises one or more servers (e.g., the server(s) 902) that support the attention controlled system 100. In other embodiments, the computing device 1000 is the client device 910. As the computing device 1000 suggests, in some embodiments, the server(s) 902 comprise the attention controlled system 100 or portions of the attention controlled system 100. In particular, in some instances, the server(s) 902 use the attention controlled system 100 to perform some or all of the functions described above with reference to FIGS. 1-8C.

As shown in FIG. 10, the computing device 1000 includes the attention controlled system 100. The attention controlled system 100 in turn includes, but is not limited to, an attribute-attention-projection generator 1002, a neural network manager 1004, an application engine 1006, and a data storage 1008. The following paragraphs describe each of these components in turn.

As shown in FIG. 10, the attribute-attention-projection generator 1002 generates attribute attention projections based on attribute codes. As suggested above, in some embodiments, the attribute-attention-projection generator 1002 comprises an additional neural network. Additionally, in certain embodiments, the attribute-attention-projection generator 1002 inserts one or more attribute attention projections between or after layers of the attention controlled neural network 102. For example, the attribute-attention-projection generator 1002 optionally inserts one or more gradient modulators between or after layers of the attention controlled neural network 102.

As further shown in FIG. 10, the neural network manager 1004 trains and/or utilizes the attention controlled neural network 102. For example, in some embodiments, the neural network manager 1004 receives training images and attribute attention projections and trains the attention controlled neural network 102 to generates attribute-modulated-feature vectors based on attribute attention projections. Relatedly, the neural network manager 1004 also optionally determines a loss based on a loss function. Based on a determined loss, the neural network manager 1004 updates attribute attention projections and parameters of the attention controlled neural network 102. After training the attention controlled neural network 102, in some embodiments, the neural network manager 1004 also applies an attribute attention projection (and parameters) to certain features extracted from a digital input image to generate an attribute-modulated-feature vector. In certain embodiments, the neural network manager 1004 applies different attribute attention projections between layers of the attention controlled neural network 102 to certain features extracted from a digital input image to generate different attribute-modulated-feature vectors.

In addition to training and/or applying the attention controlled neural network 102, in some embodiments, the attention controlled system 100 also performs tasks. As shown in FIG. 10, the application engine 1006 performs such tasks. Consistent with the disclosure above, in some embodiments, the application engine 1006 may identify an object within a digital input image, produce a word or phrase describing a digital input image, or retrieve an output digital image corresponding to a digital input image.

As also shown in FIG. 10, the attention controlled system 100 includes the data storage 1008. In certain embodiments, the data storage 1008 includes non-transitory computer readable media. Among other things, the data storage 1008 maintains the attention controlled neural network 102, attribute attention projections 1010, attribute codes 1012, and/or digital images 1014. In some embodiments, the attention controlled neural network 102 comprises a machine learning model that the neural network manager 1004 can train. The data storage 1008 maintains the attention controlled neural network 102 both during and/or after the neural network manager 1004 trains the attention controlled neural network 102. Additionally, in some embodiments, data files comprise the attribute attention projections 1010 generated by the attribute-attention-projection generator 1002. During application of the attention controlled neural network 102, for example, the attribute-attention-projection generator 1002 identifies an attribute attention projection from among the attribute attention projections 1010 based on an attribute code.

Relatedly, in certain embodiments, data files comprise the attribute codes 1012. For example, in some implementations, data files include reference tables that associate each of the attribute codes 1012 with an attribute category. Additionally, in some embodiments, the digital images 1014 may include training images, digital input images, and/or digital output images. For example, in some embodiments, the data storage 1008 maintains one or both of digital input images received for analysis and digital output images produced for presentation to a client device. As another example, in some embodiments, the data storage 1008 maintains the training images that the neural network manager 1004 uses to train the attention controlled neural network 102.

Each of the components 1002-1014 of the attention controlled system 100 can include software, hardware, or both. For example, the components 1002-1014 can include one or more instructions stored on a computer-readable storage medium and executable by processors of one or more computing devices, such as a client device or server device. When executed by the one or more processors, the computer-executable instructions of the attention controlled system 100 can cause the computing device(s) to perform the feature learning methods described herein. Alternatively, the components 1002-1014 can include hardware, such as a special-purpose processing device to perform a certain function or group of functions. Alternatively, the components 1002-1014 of the attention controlled system 100 can include a combination of computer-executable instructions and hardware.

Furthermore, the components 1002-1014 of the attention controlled system 100 may, for example, be implemented as one or more operating systems, as one or more stand-alone applications, as one or more modules of an application, as one or more plug-ins, as one or more library functions or functions that may be called by other applications, and/or as a cloud-computing model. Thus, the components 1002-1014 may be implemented as a stand-alone application, such as a desktop or mobile application. Furthermore, the components 1002-1014 may be implemented as one or more web-based applications hosted on a remote server. The components 1002-1014 may also be implemented in a suite of mobile device applications or “apps.” To illustrate, the components 1002-1014 may be implemented in a software application, including but not limited to ADOBE® CREATIVE CLOUD®, ADOBE® PHOTOSHOP®, or ADOBE® LIGHTROOM®. “ADOBE,” “CREATIVE CLOUD,” “PHOTOSHOP,” and “LIGHTROOM” are either registered trademarks or trademarks of Adobe Systems Incorporated in the United States and/or other countries.

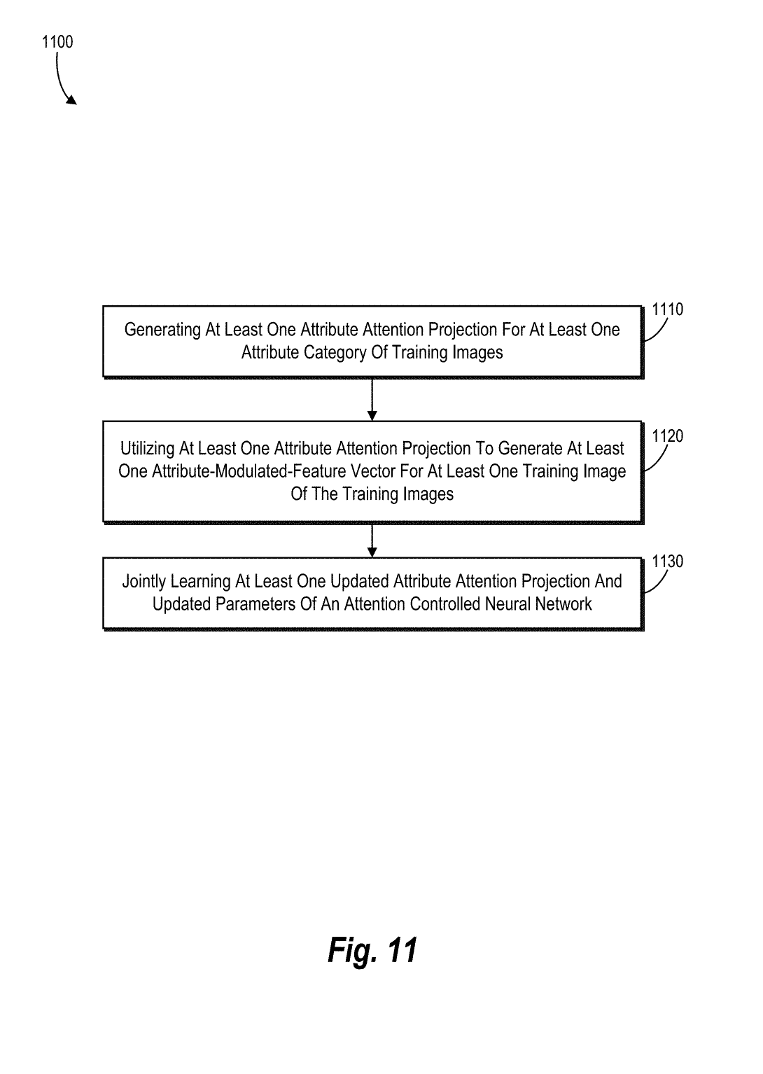

Turning now to FIG. 11, this figure illustrates a flowchart of a series of acts 1100 of training an attention controlled neural network in accordance with one or more embodiments. While FIG. 11 illustrates acts according to one embodiment, alternative embodiments may omit, add to, reorder, and/or modify any of the acts shown in FIG. 11. The acts of FIG. 11 can be performed as part of a method. Alternatively, a non-transitory computer readable storage medium can comprise instructions that, when executed by one or more processors, cause a computing device to perform the acts depicted in FIG. 11. In still further embodiments, a system can perform the acts of FIG. 11.

As shown in FIG. 11, the acts 1100 include an act 1110 of generating at least one attribute attention projection for at least one attribute category of training images. For example, in some embodiments, the act 1110 includes generating the at least one attribute attention projection based on at least one attribute code for the at least one attribute category of the training images.

To illustrate, in certain implementations, generating the at least one attribute attention projection for the at least one attribute category of the training images comprises: generating, in a first training iteration, a first attribute attention projection for a first attribute category of a first set of training images from the training images; and generating, in a second training iteration, a second attribute attention projection for a second attribute category of a second set of training images from the training images.

Additionally, in one or more embodiments, the training images comprise image triplets that include: an anchor image comprising a first attribute corresponding to the at least one attribute category; a positive image comprising a second attribute corresponding to the at least one attribute category; and a negative image comprising a third attribute corresponding to the at least one attribute category.

As further shown in FIG. 11, the acts 1100 include an act 1120 of utilizing at least one attribute attention projection to generate at least one attribute modulate feature vector for at least one training image of the training images. For example, in certain embodiments, the act 1120 includes utilizing the at least one attribute attention projection to generate at least one attribute-modulated-feature vector for at least one training image of the training images by inserting the at least one attribute attention projection between at least one set of layers of the attention controlled neural network.

As suggested above, in one or more embodiments, inserting the at least one attribute attention projection between the at least one set of layers comprises: utilizing the attention controlled neural network in the first training iteration to: generate a first feature map based on a first training image of the first set of training images; apply the first attribute attention projection to the first feature map between a first set of layers of the attention controlled neural network to generate a first discriminative feature map for the first training image; and utilizing the attention controlled neural network in the second training iteration to: generate a second feature map based on a second training image of the second set of training images; and apply the second attribute attention projection to the second feature map between a second set of layers of the attention controlled neural network to generate a first discriminative feature map for the first training image.

Relatedly, in certain embodiments, inserting the at least one attribute attention projection between the at least one set of layers comprises: utilizing a first gradient modulator in the first training iteration to apply the first attribute attention projection to the first feature map between the first set of layers; and utilizing a second gradient modulator in the second training iteration to apply the second attribute attention projection to the second feature map between the second set of layers.

As further shown in FIG. 11, the acts 1100 include an act 1130 of jointly learning at least one updated attribute attention projection and updated parameters of an attention controlled neural network. In particular, in certain implementations, the act 1130 includes jointly learning at least one updated attribute attention projection and updated parameters of the attention controlled neural network by minimizing a loss from a loss function based on the at least one attribute-modulated-feature vector.

For example, in one or more embodiments, jointly learning the at least one updated attribute attention projection and the updated parameters of the attention controlled neural network comprises: determining, in the first training iteration, a first triplet loss from a triplet-loss function based on a comparison of attribute-modulated-feature vectors for a first anchor image, a first positive image, and a first negative image from the first set of training images; jointly updating, in the first training iteration, the first attribute attention projection and parameters of the attention controlled neural network based on the first triplet loss; determining, in the second training iteration, a second triplet loss from the triplet-loss function based on a comparison of attribute-modulated-feature vectors for a second anchor image, a second positive image, and a second negative image from the second set of training images; and jointly updating, in the second training iteration, the second attribute attention projection and the parameters of the attention controlled neural network based on the second triplet loss.

In addition to the acts 1110-1130, in some embodiments, the acts 1100 further include updating the first attribute attention projection and the second attribute attention projection in multiple training iterations to comprise relatively similar values, wherein the relatively similar values indicate a correlation between the first attribute category and the second attribute category; or updating the first attribute attention projection and the second attribute attention projection in multiple training iterations to comprise relatively dissimilar values, wherein the relatively dissimilar values indicate a discorrelation between the first attribute category and the second attribute category.

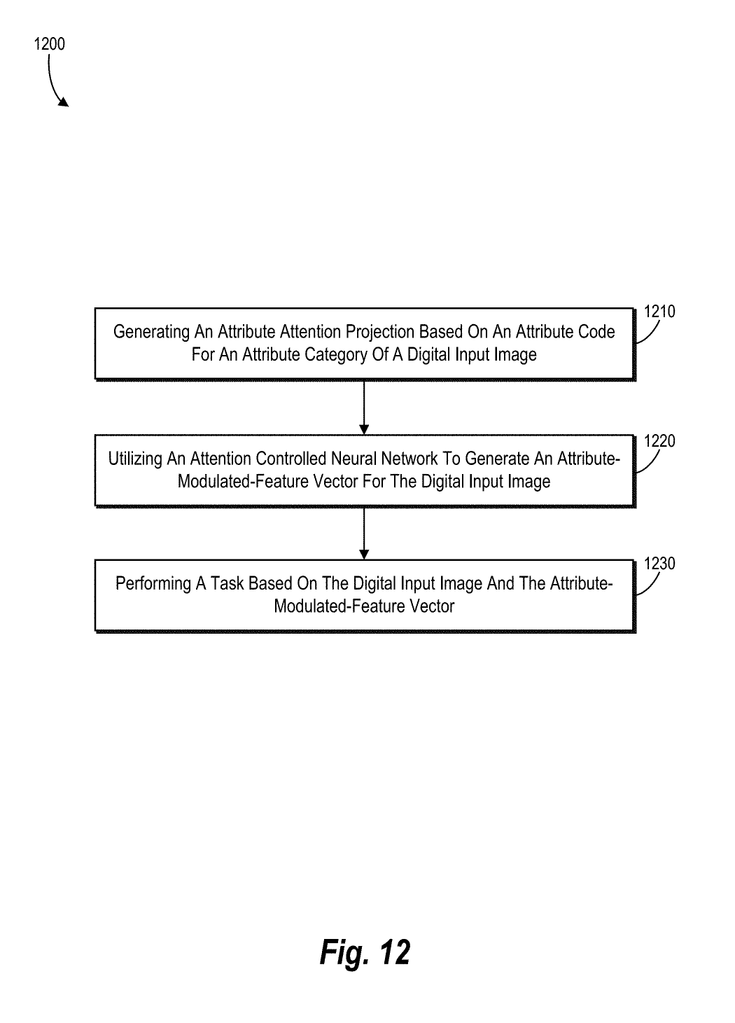

Turning now to FIG. 12, this figure illustrates a flowchart of a series of acts 1200 of applying an attention controlled neural network in accordance with one or more embodiments. While FIG. 12 illustrates acts according to one embodiment, alternative embodiments may omit, add to, reorder, and/or modify any of the acts shown in FIG. 12. The acts of FIG. 12 can be performed as part of a method. Alternatively, a non-transitory computer readable storage medium can comprise instructions that, when executed by one or more processors, cause a computing device to perform the acts depicted in FIG. 12. In still further embodiments, a system can perform the acts of FIG. 12.

As shown in FIG. 12, the acts 1200 include an act 1210 of generating an attribute attention projection based on an attribute code for an attribute category of a digital input image. For example, in some embodiments, the attribute attention projection comprises a channel-wise scaling vector or a channel-wise projection matrix. Moreover, in certain implementations, the attribute categories comprise facial-feature categories or product-feature categories.

To further illustrate, in certain implementations, generating the attribute attention projection based on the attribute code for the attribute category of the digital input image comprises utilizing an additional neural network to generate the attribute attention projection based on the attribute code.

As further shown in FIG. 12, the acts 1200 include an act 1220 of utilizing an attention controlled neural network to generate an attribute modulate feature vector for the digital input image. For example, in certain embodiments, the act 1220 includes utilizing an attention controlled neural network to generate an attribute-modulated-feature vector for the digital input image by inserting the attribute attention projection between at least one set of layers of the attention controlled neural network.

In one or more embodiments, utilizing the attention controlled neural network to generate the attribute-modulated-feature vector for the digital input image comprises utilizing the attention controlled neural network to generate the attribute-modulated-feature vector based on parameters of the attention controlled neural network.

As suggested above, in some embodiments, inserting the attribute attention projection between the at least one set of layers of the attention controlled neural network comprises utilizing the attention controlled neural network to: generate a first feature map from the digital input image; apply the attribute attention projection to the first feature map between a first set of layers of the attention controlled neural network to generate a first discriminative feature map for the digital input image; generate a second feature map based on the digital input image; and apply the attribute attention projection to the second feature map between a second set of layers of the attention controlled neural network to generate a second discriminative feature map for the digital input image.

Relatedly, in certain embodiments, inserting the attribute attention projection between at the least one set of layers of the attention controlled neural network comprises: utilizing a first gradient modulator to apply the attribute attention projection to the first feature map between a first convolutional layer and a second convolutional layer of the attention controlled neural network; and utilizing a second gradient modulator to apply the attribute attention projection to the second feature map between a third convolutional layer and a fully connected layer of the attention controlled neural network.

As further shown in FIG. 12, the acts 1200 include an act 1230 of performing a task based on the digital input image and the attribute modulate feature vector. For example, in certain implementations, performing the task based on the digital input image and the attribute-modulated-feature vector comprises retrieving, from an image database, a digital output image corresponding to the digital input image, the digital output image including an output attribute that corresponds to an input attribute of the digital input image.

In addition to the acts 1210-1230, in some embodiments, the acts 1200 further include generating a second attribute attention projection based on a second attribute code for a second attribute category of the digital input image; utilizing the attention controlled neural network to generate a second attribute-modulated-feature vector for the digital input image by inserting the second attribute attention projection between the at least one set of layers of the attention controlled neural network; generating a third attribute attention projection based on a third attribute code for a third attribute category of the digital input image; utilizing the attention controlled neural network to generate a third attribute-modulated-feature vector for the digital input image by inserting the third attribute attention projection between the at least one set of layers of the attention controlled neural network; and performing the task based the digital input image, the attribute-modulated-feature vector, the second attribute-modulated-feature vector, and the third attribute-modulated-feature vector.

Relatedly, in some embodiments, a first relative value difference separates the attribute attention projection and the second attribute attention projection, the first relative value difference indicating a correlation between the attribute category and the second attribute category; and a second relative value difference separates the attribute attention projection and the third attribute attention projection, the second relative value difference indicating a discorrelation between the attribute category and the third attribute category.

As suggested above, in some embodiments, the acts 1200 further include performing the task based on the digital input image, the attribute-modulated-feature vector, and the second attribute-modulated-feature vector by retrieving, from an image database, a digital output image corresponding to the digital input image, the digital output image including a first output attribute and a second output attribute respectfully corresponding to a first input attribute and a second attribute of the digital input image.

Embodiments of the present disclosure may comprise or utilize a special purpose or general-purpose computer including computer hardware, such as, for example, one or more processors and system memory, as discussed in greater detail below. Embodiments within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., a memory, etc.), and executes those instructions, thereby performing one or more processes, including one or more of the processes described herein.

Computer-readable media can be any available media that can be accessed by a general purpose or special purpose computer system. Computer-readable media that store computer-executable instructions are non-transitory computer-readable storage media (devices). Computer-readable media that carry computer-executable instructions are transmission media. Thus, by way of example, and not limitation, embodiments of the disclosure can comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that non-transitory computer-readable storage media (devices) can be included in computer system components that also (or even primarily) utilize transmission media.

Computer-executable instructions comprise, for example, instructions and data which, when executed at a processor, cause a general-purpose computer, special purpose computer, or special purpose processing device to perform a certain function or group of functions. In one or more embodiments, computer-executable instructions are executed on a general-purpose computer to turn the general-purpose computer into a special purpose computer implementing elements of the disclosure. The computer executable instructions may be, for example, binaries, intermediate format instructions such as assembly language, or even source code. Although the subject matter has been described in language specific to structural marketing features and/or methodological acts, it is to be understood that the subject matter defined in the appended claims is not necessarily limited to the described marketing features or acts described above. Rather, the described marketing features and acts are disclosed as example forms of implementing the claims.

Those skilled in the art will appreciate that the disclosure may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Embodiments of the present disclosure can also be implemented in cloud computing environments. In this description, “cloud computing” is defined as a subscription model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction, and then scaled accordingly.

A cloud-computing subscription model can be composed of various characteristics such as, for example, on-demand self-service, broad network access, resource pooling, rapid elasticity, measured service, and so forth. A cloud-computing subscription model can also expose various service subscription models, such as, for example, Software as a Service (“SaaS”), a web service, Platform as a Service (“PaaS”), and Infrastructure as a Service (“IaaS”). A cloud-computing subscription model can also be deployed using different deployment subscription models such as private cloud, community cloud, public cloud, hybrid cloud, and so forth. In this description and in the claims, a “cloud-computing environment” is an environment in which cloud computing is employed.

FIG. 13 illustrates a block diagram of exemplary computing device 1300 that may be configured to perform one or more of the processes described above. As shown by FIG. 13, the computing device 1300 can comprise a processor 1302, a memory 1304, a storage device 1306, an I/O interface 1308, and a communication interface 1310, which may be communicatively coupled by way of a communication infrastructure 1312. In certain embodiments, the computing device 1300 can include fewer or more components than those shown in FIG. 13. Components of the computing device 1300 shown in FIG. 13 will now be described in additional detail.

In one or more embodiments, the processor 1302 includes hardware for executing instructions, such as those making up a computer program. As an example, and not by way of limitation, to execute instructions for digitizing real-world objects, the processor 1302 may retrieve (or fetch) the instructions from an internal register, an internal cache, the memory 1304, or the storage device 1306 and decode and execute them. The memory 1304 may be a volatile or non-volatile memory used for storing data, metadata, and programs for execution by the processor(s). The storage device 1306 includes storage, such as a hard disk, flash disk drive, or other digital storage device, for storing data or instructions related to object digitizing processes (e.g., digital scans, digital models).

The I/O interface 1308 allows a user to provide input to, receive output from, and otherwise transfer data to and receive data from computing device 1300. The I/O interface 1308 may include a mouse, a keypad or a keyboard, a touch screen, a camera, an optical scanner, network interface, modem, other known I/O devices or a combination of such I/O interfaces. The I/O interface 1308 may include one or more devices for presenting output to a user, including, but not limited to, a graphics engine, a display (e.g., a display screen), one or more output drivers (e.g., display drivers), one or more audio speakers, and one or more audio drivers. In certain embodiments, the I/O interface 1308 is configured to provide graphical data to a display for presentation to a user. The graphical data may be representative of one or more graphical user interfaces and/or any other graphical content as may serve a particular implementation.

The communication interface 1310 can include hardware, software, or both. In any event, the communication interface 1310 can provide one or more interfaces for communication (such as, for example, packet-based communication) between the computing device 1300 and one or more other computing devices or networks. As an example and not by way of limitation, the communication interface 1310 may include a network interface controller (“NIC”) or network adapter for communicating with an Ethernet or other wire-based network or a wireless NIC (“WNIC”) or wireless adapter for communicating with a wireless network, such as a WI-FI.

Additionally, the communication interface 1310 may facilitate communications with various types of wired or wireless networks. The communication interface 1310 may also facilitate communications using various communication protocols. The communication infrastructure 1312 may also include hardware, software, or both that couples components of the computing device 1300 to each other. For example, the communication interface 1310 may use one or more networks and/or protocols to enable a plurality of computing devices connected by a particular infrastructure to communicate with each other to perform one or more aspects of the digitizing processes described herein. To illustrate, the image compression process can allow a plurality of devices (e.g., server devices for performing image processing tasks of a large number of images) to exchange information using various communication networks and protocols for exchanging information about a selected workflow and image data for a plurality of images.

In the foregoing specification, the present disclosure has been described with reference to specific exemplary embodiments thereof. Various embodiments and aspects of the present disclosure(s) are described with reference to details discussed herein, and the accompanying drawings illustrate the various embodiments. The description above and drawings are illustrative of the disclosure and are not to be construed as limiting the disclosure. Numerous specific details are described to provide a thorough understanding of various embodiments of the present disclosure.

The present disclosure may be embodied in other specific forms without departing from its spirit or essential characteristics. The described embodiments are to be considered in all respects only as illustrative and not restrictive. For example, the methods described herein may be performed with less or more steps/acts or the steps/acts may be performed in differing orders. Additionally, the steps/acts described herein may be repeated or performed in parallel with one another or in parallel with different instances of the same or similar steps/acts. The scope of the present application is, therefore, indicated by the appended claims rather than by the foregoing description. All changes that come within the meaning and range of equivalency of the claims are to be embraced within their scope.

We claim:

1. A system for training attention controlled neural networks to generate attribute-modulated-feature vectors using attribute attention projections comprising:
at least one processor;
at least one non-transitory computer memory comprising an attention controlled neural network, a plurality of training images, and instructions that, when executed by at least one processor, cause the system to:
generate at least one attribute attention projection for at least one attribute category of training images of the plurality of training images;
utilize the at least one attribute attention projection to generate at least one attribute-modulated-feature vector for at least one training image of the training images by inserting the at least one attribute attention projection between at least one set of layers of the attention controlled neural network; and
jointly learn at least one updated attribute attention projection and updated parameters of the attention controlled neural network by minimizing a loss from a loss function based on the at least one attribute-modulated-feature vector.

2. The system of claim 1, further comprising instructions that, when executed by the at least one processor, cause the system to generate the at least one attribute attention projection based on at least one attribute code for the at least one attribute category of the training images.

3. The system of claim 1, further comprising instructions that, when executed by the at least one processor, cause the system to generate the at least one attribute attention projection for the at least one attribute category of the training images by:
updating, in a first training iteration, a first attribute attention projection for a first attribute category of a first set of training images from the training images; and
updating, in a second training iteration, a second attribute attention projection for a second attribute category of a second set of training images from the training images.

4. The system of claim 3, further comprising instructions that, when executed by the at least one processor, cause the system to insert the at least one attribute attention projection between the at least one set of layers in part by:
utilizing the attention controlled neural network in the first training iteration to:
generate a first feature map based on a first training image of the first set of training images;
apply the first attribute attention projection to the first feature map between a first set of layers of the attention controlled neural network to generate a first discriminative feature map for the first training image;
utilizing the attention controlled neural network in the second training iteration to:
generate a second feature map based on a second training image of the second set of training images; and
apply the second attribute attention projection to the second feature map between a second set of layers of the attention controlled neural network to generate a second discriminative feature map for the second training image.

5. The system of claim 4, further comprising instructions that, when executed by the at least one processor, cause the system to:
utilize a first gradient modulator in the first training iteration to apply the first attribute attention projection to the first feature map between the first set of layers; and
utilize a second gradient modulator in the second training iteration to apply the second attribute attention projection to the second feature map between the second set of layers.

6. The system of claim 3, further comprising instructions that, when executed by the at least one processor, cause the system to jointly learn the at least one updated attribute attention projection and the updated parameters of the attention controlled neural network by:
determining, in the first training iteration, a first triplet loss from a triplet-loss function based on a comparison of attribute-modulated-feature vectors for a first anchor image, a first positive image, and a first negative image from the first set of training images; and
jointly updating, in the first training iteration, the first attribute attention projection and parameters of the attention controlled neural network based on the first triplet loss.

7. The system of claim 6, further comprising instructions that, when executed by the at least one processor, cause the system to jointly learn the at least one updated attribute attention projection and the updated parameters of the attention controlled neural network by:
determining, in the second training iteration, a second triplet loss from the triplet-loss function based on a comparison of attribute-modulated-feature vectors for a second anchor image, a second positive image, and a second negative image from the second set of training images; and
jointly updating, in the second training iteration, the second attribute attention projection and the parameters of the attention controlled neural network based on the second triplet loss.

8. The system of claim 7, further comprising instructions that, when executed by the at least one processor, cause the system to:
update the first attribute attention projection and the second attribute attention projection in multiple training iterations to comprise relatively similar values, wherein the relatively similar values indicate a correlation between the first attribute category and the second attribute category; or
update the first attribute attention projection and the second attribute attention projection in multiple training iterations to comprise relatively dissimilar values, wherein the relatively dissimilar values indicate a discorrelation between the first attribute category and the second attribute category.

9. A non-transitory computer readable medium storing instructions thereon that, when executed by at least one processor, cause a computing device to:
generate an attribute attention projection based on an attribute code for an attribute category of a digital input image;
utilize an attention controlled neural network to generate an attribute-modulated-feature vector for the digital input image by inserting the attribute attention projection between at least one set of layers of the attention controlled neural network; and
perform a task based on the digital input image and the attribute-modulated-feature vector.

10. The non-transitory computer readable medium of claim 9, further comprising instructions that, when executed by the at least one processor, cause the computing device to utilize the attention controlled neural network to generate the attribute-modulated-feature vector based on parameters of the attention controlled neural network.

11. The non-transitory computer readable medium of claim 9, further comprising instructions that, when executed by the at least one processor, cause the computing device to utilize an additional neural network to generate the attribute attention projection based on the attribute code.

12. The non-transitory computer readable medium of claim 9, wherein the attribute attention projection comprises a channel-wise scaling vector or a channel-wise projection matrix.

13. The non-transitory computer readable medium of claim 9, further comprising instructions that, when executed by the at least one processor, cause the computing device to insert the attribute attention projection between the at least one set of layers in part by utilizing the attention controlled neural network to:
generate a first feature map from the digital input image;
apply the attribute attention projection to the first feature map between a first set of layers of the attention controlled neural network to generate a first discriminative feature map for the digital input image;
generate a second feature map based on the digital input image; and
apply the attribute attention projection to the second feature map between a second set of layers of the attention controlled neural network to generate a second discriminative feature map for the digital input image.

14. The non-transitory computer readable medium of claim 13, further comprising instructions that, when executed by the at least one processor, cause the computing device to:
utilize a first gradient modulator to apply the attribute attention projection to the first feature map between a first convolutional layer and a second convolutional layer of the attention controlled neural network; and
utilize a second gradient modulator to apply the attribute attention projection to the second feature map between a third convolutional layer and a fully-connected layer of the attention controlled neural network.

15. The non-transitory computer readable medium of claim 9, further comprising instructions that, when executed by the at least one processor, cause the computing device to:
generate a second attribute attention projection based on a second attribute code for a second attribute category of the digital input image;
utilize the attention controlled neural network to generate a second attribute-modulated-feature vector for the digital input image by inserting the second attribute attention projection between the at least one set of layers of the attention controlled neural network;
generate a third attribute attention projection based on a third attribute code for a third attribute category of the digital input image;
utilize the attention controlled neural network to generate a third attribute-modulated-feature vector for the digital input image by inserting the third attribute attention projection between the at least one set of layers of the attention controlled neural network; and
perform the task based the digital input image, the attribute-modulated-feature vector, the second attribute-modulated-feature vector, and the third attribute-modulated-feature vector.

16. The non-transitory computer readable medium of claim 15, wherein:
a first relative value difference separates the attribute attention projection and the second attribute attention projection, the first relative value difference indicating a correlation between the attribute category and the second attribute category; and
a second relative value difference separates the attribute attention projection and the third attribute attention projection, the second relative value difference indicating a discorrelation between the attribute category and the third attribute category.

17. A method for training and applying attention controlled neural networks comprising:
performing a step for training an attention controlled neural network to generate attribute-modulated-feature vectors using attribute attention projections for attribute categories; and
performing a step for generating an attribute-modulated-feature vector for a digital input image using an attribute attention projection and the trained attention controlled neural network; and
performing a task based on the digital input image and the attribute-modulated-feature vector for the digital input image.

18. The method of claim 17, wherein the attribute categories comprise facial-feature categories or product-feature categories.

19. The method of claim 17, wherein performing the task based on the digital input image and the attribute-modulated-feature vector for the digital input image comprises retrieving, from an image database, a digital output image corresponding to the digital input image, the digital output image including an output attribute that corresponds to an input attribute of the digital input image.

20. The method of claim 17, further comprising:
generating an additional attribute-modulated-feature vector for the digital input image using an additional attribute attention projection and the trained attention controlled neural network; and
performing the task based on the digital input image, the attribute-modulated-feature vector, and the additional attribute-modulated-feature vector by retrieving, from an image database, a digital output image corresponding to the digital input image, the digital output image including a first output attribute and a second output attribute respectfully corresponding to a first input attribute and a second attribute of the digital input image.
